(19) United States
(12) Patent Application Publication
(10) Pub. No.: US 2024/0032020 A1
(43) Pub. Date: Jan. 25, 2024

(54) METHOD AND APPARATUS OF MANAGING RADIO BEARER FOR PROVIDING EXTENDED REALITY SERVICE IN COMMUNICATION SYSTEM

(71) Applicant: ELECTRONICS AND TELECOMMUNICATIONS RESEARCH INSTITUTE, Daejeon (KR)

(72) Inventor: Jae Heung KIM, Daejeon (KR)

(73) Assignee: ELECTRONICS AND TELECOMMUNICATIONS RESEARCH INSTITUTE, Daejeon (KR)

(21) Appl. No.: 18/356,039

(22) Filed: Jul. 20, 2023

(30) Foreign Application Priority Data
Jul. 20, 2022 (KR) 10-2022-0089602
Jul. 28, 2022 (KR) 10-2022-0093862
Jul. 19, 2023 (KR) 10-2023-0093609

(51) Int. Cl. H04W 72/1263; H04W 72/232; H04W 72/542; H04W 76/30

(52) U.S. Cl. CPC H04W 72/1263; H04W 72/232; H04W 72/542; H04W 76/30

(57) ABSTRACT

A method of a terminal may comprise: establishing a PDU session and one or more data radio bearers DRBs with a base station; receiving, from the base station, first DCI including first dynamic scheduling information corresponding to a first DRB among the one or more DRBs; performing an initial transmission/reception operation for first data with the base station based on the first dynamic scheduling information; and performing a re-transmission/reception operation for the first data with the base station based on first semi-static scheduling information configured by the base station.

### CROSS-REFERENCE TO RELATED APPLICATIONS

This application claims priority to Korean Patent Applications No. 10-2022-0089602, filed on Jul. 20, 2022, No. 10-2022-0093862, filed on Jul. 28, 2022, and No. 10-2023-0093609, filed on Jul. 19, 2023, with the Korean Intellectual Property Office (KIPO), the entire contents of which are hereby incorporated by reference.

### BACKGROUND

### 1. Technical Field

Exemplary embodiments of the present disclosure relate to a communication technique for providing extended reality (XR) services and more particularly, to a technique for quality of service (QoS) handling and radio bearer management therefor.

### 2. Related Art

In order to overcome performance degradation due to interference in a radio channel due to rapid increase in the number of users and rapid increase in wireless data and to improve terminal performance at an edge of a base station (or cell), a plurality of small base stations and/or radio access points may be introduced into a communication system. The small base station may refer to a small cell. The radio access point may refer to a transmission and reception point (TRP), remote radio head (RRH), relay, and/or repeater.

The small cell and/or radio access point may support a small service coverage. Instead of a small cell and/or radio access point that implements all radio protocol functions, a small cell and/or radio access point that supports functional split, carrier aggregation (CA), dual connectivity (DC), and/or duplication transmission (DT) schemes may be deployed in the communication system. When the functional split is applied, functions of a base station (e.g., small cell, radio access point) may be distributed to a plurality of remote radio transmission/reception blocks and one centralized baseband processing functional block.

In the communication system, various types of base stations (e.g., small cells, radio access points) may be deployed. In order for the communication system to provide various services, methods for efficiently/variably using available resources are required. For example, a communication method, energy consumption power control method, and/or resource scheduling method may be required in an unlicensed band. The resource scheduling method may include a scheduling method in the time and/or frequency domain.

For extended reality (XR) services in the communication system, a method for guaranteeing a quality of service (QoS) according to an attribute of a packet (e.g., video packet), a method for handling a QoS between a user plane function (UPF) and a terminal to guarantee a transmission reliability on a radio channel, and/or a method for managing radio bearers between a base station and a terminal may be required.

### SUMMARY

Exemplary embodiments of the present disclosure are directed to providing a method and an apparatus for QoS handling and radio bearer management in a communication system.

According to a first exemplary embodiment of the present disclosure, a method of a terminal may comprise: establishing a packet data unit (PDU) session and one or more data radio bearers (DRBs) with a base station; receiving, from the base station, first downlink control information (DCI) including first dynamic scheduling information corresponding to a first DRB among the one or more DRBs; performing an initial transmission/reception operation for first data with the base station based on the first dynamic scheduling information; and performing a re-transmission/reception operation for the first data with the base station based on first semi-static scheduling information configured by the base station.

The one or more DRBs may include the first DRB and a second DRB, the first DRB and the second DRB may be mapped to one quality of service (QoS) flow, the first DRB may be used for transmission and reception of the first data, the second DRB may be used for transmission and reception of second data, and the first data and the second data may have different importance.

The first semi-static scheduling information may be configured for the first DRB, and second semi-static scheduling information configured for the second DRB may be distinguished from the first semi-static scheduling information.

When downlink communication is performed between the terminal and the base station, the first semi-static scheduling information may indicate semi-persistent (SPS) resources, and when uplink communication is performed between the terminal and the base station, the first semi-static scheduling information may indicate configured grant (CG) resources.

The first DCI may further include validity time information of the first semi-static scheduling information, and the re-transmission/reception operation for the first data may be performed within a valid time indicated by the validity time information.

The method may further comprise: when the valid time expires, receiving, from the base station, second DCI including second dynamic scheduling information for new data.

The method may further comprise: when a communication service provided by the base station is terminated, performing, with the base station, a release procedure of the PDU session and the one or more DRBs, wherein in the release procedure, resources indicated by the first-semi-static scheduling information may be released.

The method may further comprise: when a video packet is generated, classifying the video packet into the first data and second data based on a classification condition, wherein the first data may be mapped to the first DRB, the second data may be mapped to a second DRB among the one or more DRBs, the first data may be an I-frame, and the second data may be a P-frame.

According to a second exemplary embodiment of the present disclosure, a method of a base station may comprise: establishing a packet data unit (PDU) session and one or more data radio bearers (DRBs) with a terminal; transmitting, to the terminal, first semi-static scheduling information corresponding to a first DRB among the one or more DRBs; transmitting, to the terminal, first downlink control information (DCI) including first dynamic scheduling information corresponding to the first DRB; performing an initial transmission/reception operation for first data with the terminal based on the first dynamic scheduling information; and performing a re-transmission/reception operation for the first data with the terminal based on the first semi-static scheduling information.

The one or more DRBs may include the first DRB and a second DRB, the first DRB and the second DRB may be mapped to one quality of service (QoS) flow, the first DRB may be used for transmission and reception of the first data, the second DRB may be used for transmission and reception of second data, and the first data and the second data may have different importance.

The method may further comprise: transmitting, to the terminal, second semi-static scheduling information corresponding to the second DRB, wherein the second semi-static scheduling information configured for the second DRB may be distinguished from the first semi-static scheduling information configured for the first DRB.

When downlink communication is performed between the terminal and the base station, the first semi-static scheduling information may indicate semi-persistent (SPS) resources, and when uplink communication is performed between the terminal and the base station, the first semi-static scheduling information may indicate configured grant (CG) resources.

The first DCI may further include validity time information of the first semi-static scheduling information, and the re-transmission/reception operation for the first data may be performed within a valid time indicated by the validity time information.

The method may further comprise: when the valid time expires, transmitting, to the terminal, second DCI including second dynamic scheduling information for new data.

The method may further comprise: when a communication service provided by the base station is terminated, performing, with the terminal, a release procedure of the PDU session and the one or more DRBs, wherein in the release procedure, resources indicated by the first-semi-static scheduling information may be released.

According to a third exemplary embodiment of the present disclosure, a terminal may comprise a processor, wherein the processor may cause the terminal to perform: establishing a packet data unit (PDU) session and one or more data radio bearers (DRBs) with a base station; receiving, from the base station, first downlink control information (DCI) including first dynamic scheduling information corresponding to a first DRB among the one or more DRBs; performing an initial transmission/reception operation for first data with the base station based on the first dynamic scheduling information; and performing a re-transmission/reception operation for the first data with the base station based on first semi-static scheduling information configured by the base station.

The one or more DRBs may include the first DRB and a second DRB, the first DRB and the second DRB may be mapped to one quality of service (QoS) flow, the first DRB may be used for transmission and reception of the first data, the second DRB may be used for transmission and reception of second data, and the first data and the second data may have different importance.

When downlink communication is performed between the terminal and the base station, the first semi-static scheduling information may indicate semi-persistent (SPS) resources, and when uplink communication is performed between the terminal and the base station, the first semi-static scheduling information may indicate configured grant (CG) resources.

The first DCI may further include validity time information of the first semi-static scheduling information, and the re-transmission/reception operation for the first data may be performed within a valid time indicated by the validity time information.

The processor may further cause the terminal to perform: when a communication service provided by the base station is terminated, performing, with the base station, a release procedure of the PDU session and the one or more DRBs, wherein in the release procedure, resources indicated by the first-semi-static scheduling information may be released.

According to the present disclosure, the functional split scheme may be applied to a communication system, and method(s) for configuring and/or signaling parameters considering an attribute of XR service packets may be performed in an interface between a terminal and a network node (e.g., user plane function (UPF), access and mobility management function (AMF), base station, small cell, and radio access point). According to the above-described method(s), a QoS handling operation can be performed on a QoS flow basis, and radio bearers can be efficiently managed. Therefore, the performance of the communication system can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of an apparatus.

FIG. 3 is a conceptual diagram illustrating a first exemplary embodiment of operation states of a terminal in a communication system.

FIG. 4 is a conceptual diagram illustrating a first exemplary embodiment of a method for configuring bandwidth parts (BWPs) in a communication system.

FIG. 5 is a conceptual diagram illustrating a second exemplary embodiment of a communication system.

FIG. 6 is a conceptual diagram illustrating a first exemplary embodiment of a method of providing a service using a plurality of radio access points in a communication system.

FIG. 7 is a conceptual diagram illustrating a first exemplary embodiment of a protocol structure of a user plane interface (e.g., NG-U interface) and a control plane interface (e.g., NG-C interface) of a UPF.

FIG. 8 is a conceptual diagram illustrating a first exemplary embodiment of QoS flow mapping between nodes for QoS handling in a communication system.

FIG. 9 is a conceptual diagram illustrating a first exemplary embodiment of a method for mapping I-frame(s) and P-frame(s) in a communication system.

FIG. 10 is a sequence chart illustrating a first exemplary embodiment of a method for distinguishing I-frame(s) and P-frame(s) in a communication system.

FIG. 11 is a sequence chart illustrating a first exemplary embodiment of a video service radio resource allocation method between a base station and a terminal.

FIG. 12 is a conceptual diagram illustrating a first exemplary embodiment of a GOP for video service.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and redundant description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. ‘Configuration of information element(s) (e.g., parameter(s))’ may mean that the corresponding information element(s) are signaled. ‘Configuration of a resource (e.g., resource region)’ may mean that configuration information of the corresponding resource is signaled. The signaling may be performed based on at least one of system information (SI) signaling (e.g., transmission of system information block (SIB) and/or master information block (MIB)), RRC signaling (e.g., transmission of RRC parameters and/or higher layer parameters), MAC control element (CE) signaling, PHY signaling (e.g., transmission of downlink control information (DCI), uplink control information (UCI), and/or sidelink control information (SCI)), or a combination thereof.

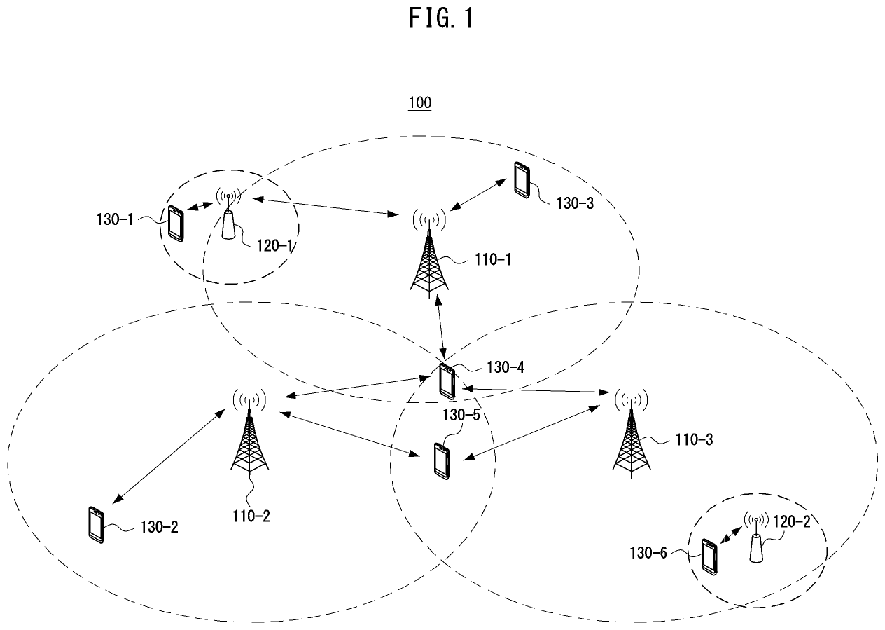

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like. The communication system 100 may refer to a radio access network (RAN).

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

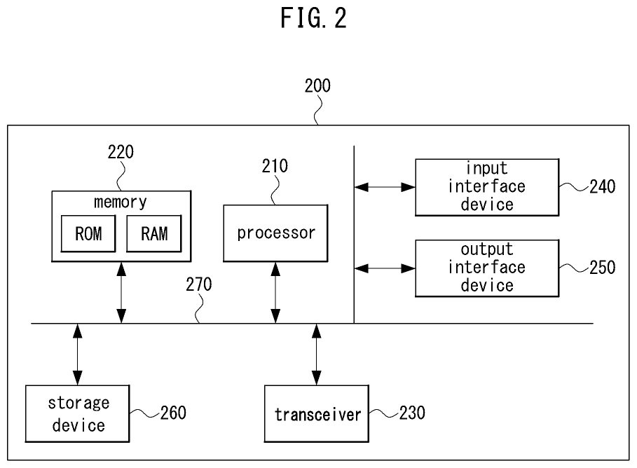

FIG. 2 is a block diagram illustrating a first exemplary embodiment of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to operations of the plurality of base stations 110-1, 110-2, 110-3, 120-1, and 120-2, operations supported by the plurality of base stations 110-1, 110-2, 110-3, 120-1, and 120-2, or the like. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

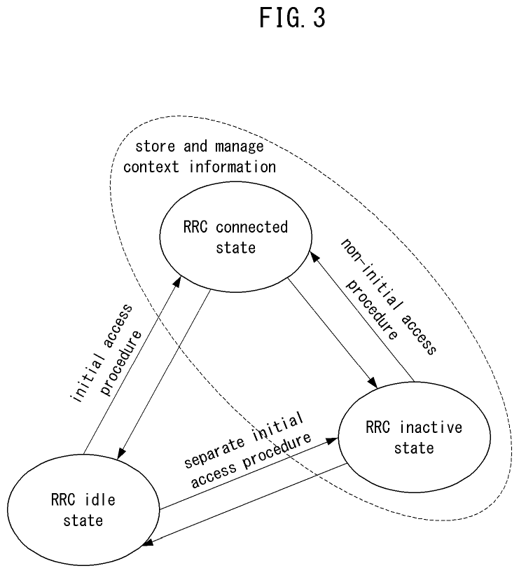

FIG. 3 is a conceptual diagram illustrating a first exemplary embodiment of operation states of a terminal in a communication system.

Referring to FIG. 3, in a radio resource control (RRC) layer of the communication system, states (e.g., operation states) of a terminal may be classified into an RRC connected state, RRC inactive state, and RRC idle state. When the terminal operates in the RRC connected state or the RRC inactive state, a base station of a RAN and the terminal may store and/or manage at least one of RRC connection configuration information, RRC context information, or access stratum (AS) context information of the terminal.

In the RRC connected state, the terminal may receive allocation information of physical layer control channels and/or reference signals necessary for maintaining RRC connection configuration and/or transmitting and receiving packets (e.g., data). The reference signal may be a reference signal for demodulating data, a reference signal for measuring a channel quality, and/or a reference signal for beamforming. The terminal in the RRC connected state may be able to transmit and receive packets (e.g., data) without additional delay. In the present disclosure, the packet may refer to data, data unit, and/or information.

In the RRC inactive state, the terminal may perform a mobility management function corresponding to the RRC idle state. Although the terminal in the RRC inactive state is in a state of being connected to the base station, a data bearer for transmitting and receiving packets may not be configured in the terminal in the RRC inactive state, and functions such as the MAC layer may be inactivated in the terminal in the RRC inactive state. In order to transmit data, the terminal in the RRC inactive state may transition to the RRC connected state by performing a non-initial access procedure. Alternatively, the terminal in the RRC inactive state may transmit limited data allowed in the RRC inactive state. The limited data may be data having a limited size, data having a limited quality of service, and/or data belonging to a limited type of service.

From the perspective of the radio access network, a connection established between the terminal in the RRC idle state and the base station may not exist. Connection configuration information and/or context information (e.g., RRC context information, AS context information) for the terminal in the RRC idle state may not be stored in the base station and/or a control function block of the radio access network. The terminal in the RRC idle state may perform an initial access procedure to transition to the RRC connected state. Although the terminal in the RRC idle state performs an initial access procedure to transition to the RRC connected state, the state of the terminal may transition from the RRC idle state to the RRC inactive state according to determination of the base station.

The terminal in the RRC idle state may transition to the RRC inactive state by performing an initial access procedure or a separate access procedure defined for transition to the RRC inactive state. When a limited service is provided to the terminal, the operation state of the terminal may transition from the RRC idle state to the RRC inactive state. Alternatively, the operation state of the terminal may transition from the RRC idle state to the RRC inactive state according to capability of the terminal.

The base station and/or the control function block of the radio access network may configure condition(s) by which the terminal can transition to the RRC inactive state in consideration of one or more of the type, capability, and/or service (e.g., service currently being provided, service to be provided) of the terminal, and may control the transition operation to the RRC inactive state based on the configured condition(s). When the base station allows transition to the RRC inactive state or when it is configured to be able to transition to the RRC inactive state, the operation state of the terminal may transition from the RRC connected state or the RRC idle state to the RRC inactive state.

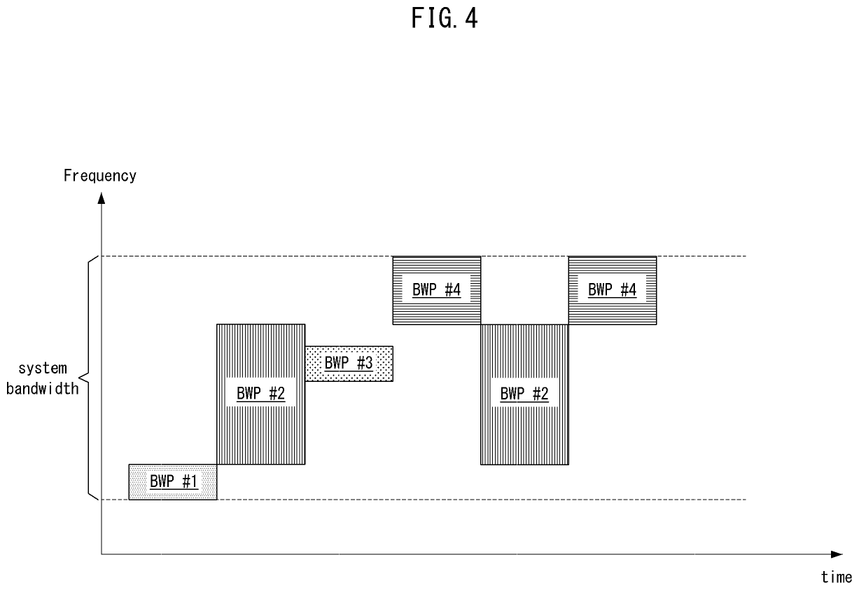

FIG. 4 is a conceptual diagram illustrating a first exemplary embodiment of a method for configuring bandwidth parts (BWPs) in a communication system.

Referring to FIG. 4, a plurality of bandwidth parts (e.g., BWPs #1 to #4) may be configured within a system bandwidth of the base station. The BWPs #1 to #4 may be configured not to be larger than the system bandwidth of the base station. The bandwidths of the BWPs #1 to #4 may be different, and different subcarrier spacings (SCSs) may be applied to the BWPs #1 to #4. For example, the bandwidth of the BWP #1 may be 10 MHz, and the BWP #1 may have a 15 kHz SCS. The bandwidth of the BWP #2 may be 40 MHz, and the BWP #2 may have a 15 kHz SCS. The bandwidth of the BWP #3 may be 10 MHz, and the BWP #3 may have a 30 kHz SCS. The bandwidth of the BWP #4 may be 20 MHz, and the BWP #4 may have a 60 kHz SCS.

The BWPs may be classified into an initial BWP (e.g., first BWP), an active BWP (e.g., activated BWP), and a default BWP. The terminal may perform an initial access procedure (e.g., access procedure) with the base station in the initial BWP. One or more BWPs may be configured through an RRC connection configuration message, and one BWP among the one or more BWPs may be configured as the active BWP. Each of the terminal and the base station may transmit and receive packets in the active BWP among the configured BWPs. Therefore, the terminal may perform a monitoring operation on control channels for packet transmission and reception in the active BWP.

The terminal may switch the operating BWP from the initial BWP to the active BWP or the default BWP. Alternatively, the terminal may switch the operating BWP from the active BWP to the initial BWP or the default BWP. The BWP switching operation may be performed based on an indication of the base station or a timer. The base station may transmit information indicating the BWP switching to the terminal using one or more of an RRC message, a MAC message (e.g., MAC control element (CE)), and a PHY message (e.g., DCI). The terminal may receive the information indicating the BWP switching from the base station, and may switch the operating BWP of the terminal to a BWP indicated by the received information.

When a random access (RA) resource is not configured in the active uplink (UL) BWP in the NR communication system, the terminal may switch the operating BWP of the terminal from the active UL BWP to the initial UL BWP in order to perform a random access procedure. The operating BWP may be a BWP in which the terminal performs communication (e.g., transmission and reception operation of a signal and/or channel).

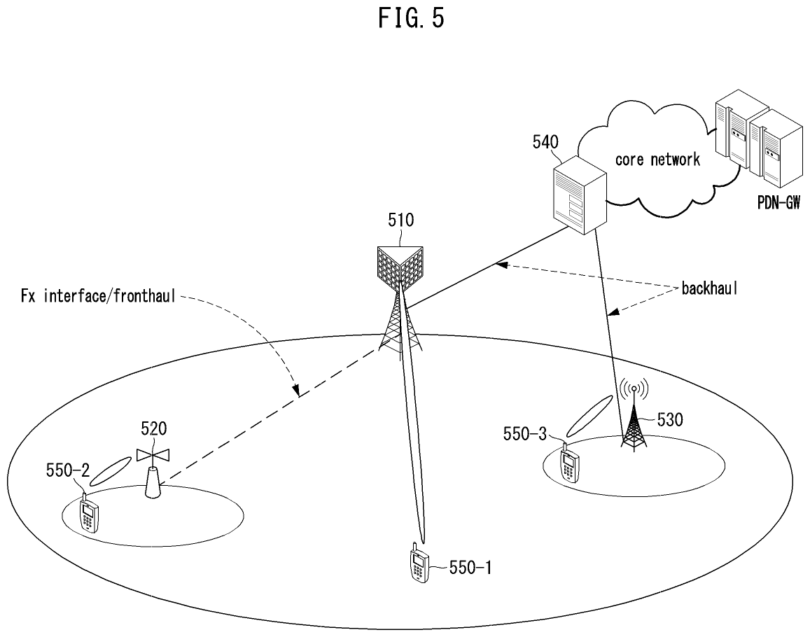

FIG. 5 is a conceptual diagram illustrating a second exemplary embodiment of a communication system.

Referring to FIG. 5, a communication system may include a core network and an access network. The core network supporting the 4G communication may include an MME, GW (e.g., S-GW, P-GW), and the like. A function block supporting the GW and the MME may be referred to as a GW/MME 540. The core network supporting the 5G communication may include an AMF, UPF, PDN-GW, and the like. A function block supporting the UPF and the AMF may be referred to as a UPF/AMF 540. The access network may include a base station 510, radio access point 520, small base station 530, and terminals 550-1, 550-2, and 550-3. The base station 510 may mean a macro base station. The base station 510 and/or the small base station 530 may be connected to a node (e.g., end node) of the core network through a backhaul. The node (e.g., end node) of the core network may be the GW, UPF, MME, AMF, or the like.

The function split scheme may be applied to the base station 510 and the small base station 530. In this case, each of the base station 510 and the small base station 530 may include one central unit (CU) and one or more distributed units (DUs). The CU may be a logical node that performs functions of an RRC layer, service data application protocol (SDAP) layer, and/or packet data convergence protocol (PDCP) layer. The CU may control operations of one or more DUs. The CU may be connected to an end node of the core network using an S1 interface-based backhaul or an NG interface-based backhaul. The S1 interface-based backhaul may refer to a backhaul in the 4G communication system, and the NG interface-based backhaul may refer to a backhaul in the 5G communication system.

The DU may be a logical node that performs functions of a radio link control (RLC) layer, MAC layer, and/or PDCP layer. The DU may support one or more cells. The DU may be connected to the CU in a wired or wireless manner using an F1 interface. When a wireless scheme is used, a connection between the DU and the CU may be configured in an integrated access and backhaul (IAB) scheme.

Each of the base station 510 and the small base station 530 may be connected to the radio access point 520 in a wired or wireless manner using an Fx interface (or fronthaul). In the present disclosure, the base station (e.g., macro base station, small base station) may refer to a cell, DU, and/or the like. The radio access point may refer to a transmission and reception point (TRP), remote radio head (RRH), relay, or repeater. The TRP may perform at least one of a downlink transmission function and an uplink reception function. The radio access point 520 may perform only radio frequency (RF) functions.

Alternatively, the radio access point 520 may perform RF functions and some functions of the DU (e.g., some functions of a physical (PHY) layer and/or the MAC layer). Some functions of the DU, which are supported by the radio access point 520, may include lower functions of the PHY layer, functions of the PHY layer, and/or lower functions of the MAC layer. The Fx interface between the base station 510 or 530 and the radio access point 520 may be defined differently depending on the function(s) supported by the radio access point 520.

Each of the radio access point 520 of FIG. 5 and the base stations 110-1, 110-2, 110-3, 120-1, 120-2, 510, and 530 of FIGS. 1 and 5 may support OFDM, OFDMA, SC-FDMA, or NOMA-based downlink communication and/or uplink communication. Each of the radio access point 520 and the base stations 110-1, 110-2, 110-3, 120-1, 120-2, 510, and 530 may support beamforming functions using an antenna array in a transmission carrier of a millimeter wave band. In this case, a service through each beam may be provided without interference between beams within the base station. One beam may provide services for a plurality of terminals.

Each of the radio access point 520 and the plurality of base stations 110-1, 110-2, 110-3, 120-1, 120-2, 510, and 530 may perform MIMO transmission (e.g., single user (SU)-MIMO, multi user (MU)-MIMO, massive MIMO, etc.), coordinated multipoint (CoMP) transmission, carrier aggregation (CA) transmission, transmission in an unlicensed band, device-to-device (D2D) communication (or proximity services (ProSe), sidelink communication), and/or the like. Here, each of the plurality of terminals 130-1, 130-2, 130-3, 130-4, 130-5, 130-6, 550-1, 550-2, and 550-3 may perform operations corresponding to operations of the radio access point 520 and/or the plurality of base stations 110-1, 110-2, 110-3, 120-1, 120-2, 510, and 530 and/or operations supported by the radio access point 520 and/or the plurality of base stations 110-1, 110-2, 110-3, 120-1, 120-2, 510, and 530. For example, the second base station 110-2 may transmit a signal to the fourth terminal 130-4 based on the SU-MIMO scheme, and the fourth terminal 130-4 may receive the signal from the second base station 110-2 based on the SU-MIMO scheme. Alternatively, the second base station 110-2 may transmit signals to the fourth terminal 130-4 and the fifth terminal 130-5 based on the MU-MIMO scheme, and each of the fourth terminal 130-4 and the fifth terminal 130-5 may receive the signal from the second base station 110-2 based on the MU-MIMO scheme.

The first base station 110-1, the second base station 110-2, and the third base station 110-3 may transmit a signal to the fourth terminal 130-4 based on the COMP scheme, and the fourth terminal 130-4 may receive the signal from the first base station 110-1, the second base station 110-2, and the third base station 110-3 based on the COMP scheme. Each of the plurality of base stations 110-1, 110-2, 110-3, 120-1, and 120-2 may transmit and receive signals with the terminals 130-1, 130-2, 130-3, 130-4, 130-5, and 130-6 belonging to its own cell coverage based on the CA scheme. Each of the first base station 110-1, the second base station 110-2, and the third base station 110-3 may coordinate D2D communication between the fourth terminal 130-4 and the fifth terminal 130-5, and the fourth terminal 130-4 and the fifth terminal 130-5 may perform the D2D communication according to coordination of the second base station 110-2 and the third base station 110-3, respectively.

Hereinafter, operation methods of a communication node in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the communication system, the UPF (or, GW) may refer to an end communication node of the core network that exchanges packets (e.g., control information, data) with the base station. In the communication system, the AMF (or, MME) may refer to a communication node in the core network, which performs control functions in a radio access section (or, interface) of the terminal. Here, each of the backhaul link, fronthaul link, Xhaul link, DU, CU, BBU block, S-GW, MME, AMF, and UPF may be referred to as a different term according to a function of a communication protocol depending on a radio access technology (RAT) or a constituent function of the core network.

In order to perform a mobility support function and a radio resource management function, the base station may transmit a synchronization signal (e.g., synchronization signal/physical broadcast channel (SS/PBCH) block or synchronization signal block (SSB)) and/or a reference signal. In order to support multiple numerologies, frame formats supporting symbols having different lengths may be configured. In this case, the terminal may perform a monitoring operation on the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication system is configured, and/or a frame format applied to radio resources in which a synchronization symbol burst capable of identifying a cell in the NR communication system is transmitted.

The frame format may refer to information of configuration parameters (e.g., values of the configuration parameters, offset, index, identifier, range, periodicity, interval, duration, etc.) for a subcarrier spacing, control channel (e.g., CORESET), symbol, slot, and/or reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the base station 510 may transmit a synchronization signal and/or a reference signal so that a terminal located within its service coverage can discover the base station 510 to perform downlink synchronization maintenance, beam configuration, or link monitoring operations. The terminal 550-1 connected to the base station 510 (e.g., serving base station) may receive physical layer radio resource configuration information for connection configuration and radio resource management from the base station 510.

The physical layer radio resource configuration information may mean configuration parameters included in RRC control messages of the LTE communication system or the NR communication system. For example, the resource configuration information may include PhysicalConfigDedicated, PhysicalCellGroupConfig, PDCCH-Config(Common), PDSCH-Config(Common), PDCCH-ConfigSIB1, ConfigCommon, PUCCH-Config(Common), PUSCH-Config(Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of the base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, slot, and subframe that exist within one radio frame (e.g., a frame of 10 ms) may be configured differently.
Configuration information of transmission a frequency and a frame format of a base station
   Transmission frequency configuration information: information on all transmission carriers (i.e., cell-specific transmission frequency) in the base station, information on bandwidth parts (BWPs) in the base station, information on a transmission reference time or time difference between transmission frequencies of the base station (e.g., a transmission periodicity or offset parameter indicating the transmission reference time (or time difference) of the synchronization signal), etc.
   Frame format configuration information: configuration parameters of a mini-slot, slot, and subframe having a different symbol length according to a subcarrier spacing
Configuration information of a downlink reference signal (e.g., channel state information-reference signal (CSI-RS), common reference signal (Common-RS), etc.)
   Configuration parameters such as a transmission periodicity, transmission position, code sequence, or masking (or scrambling) sequence for a reference signal, which are commonly applied within the coverage of the base station (or beam).
Configuration information of an uplink control signal
   Configuration parameters such as a sounding reference signal (SRS), uplink beam sweeping (or beam monitoring) reference signal, uplink grant-free radio resources (or, preambles), etc.
Configuration information of a physical downlink control channel (e.g., PDCCH)
   Configuration parameters such as a reference signal for PDCCH demodulation, beam common reference signal (e.g., reference signal that can be received by all terminals within a beam coverage), beam sweeping (or beam monitoring) reference signal, reference signal for channel estimation, etc.
Configuration information of a physical uplink control channel (e.g., PDCCH)
Scheduling request signal configuration information
Configuration information for a feedback (acknowledgement (ACK) or negative ACK (NACK)) transmission resource in a hybrid automatic repeat request (HARD) procedure
Number of antenna ports, antenna array information, beam configuration or beam index mapping information for application of beamforming techniques
Configuration information of a downlink signal and/or an uplink signal (or uplink access channel resource) for beam sweeping (or beam monitoring)
Configuration information of parameters for beam configuration, beam recovery, beam reconfiguration, or radio link re-establishment operation, beam change operation within the same base station, reception signal of a beam triggering handover execution to another base station, timers controlling the above-described operations, etc.

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the present disclosure, ‘Resource-Config information’ may be a control message including one or more parameters of the physical layer radio resource configuration information. In addition, the ‘Resource-Config information’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group). A terminal group may include one or more terminals.

The configuration information included in the ‘Resource-Config information’ may be transmitted through one control message or different control messages according to the attributes of the configuration information. The beam index information may not express the index of the transmission beam and the index of the reception beam explicitly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station. For example, when a communication service is provided using beam configuration (e.g., beam pairing) between the base station and the terminal, the terminal may perform a search operation or a monitoring operation of a radio channel by using a synchronization signal (e.g., SS/PBCH block) and/or a reference signal (e.g., CSI-RS) of a beam configured with the base station, or a beam that can be received. Here, the expression that a communication service is provided through a beam may mean that a packet is transmitted and received through an active beam among one or more configured beams. In the NR communication system, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from system information or common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, procedure for recovering a radio link, procedure for detecting (or declaring) a radio link failure, and procedure for re-establishing a radio link according to the RLM operation may be performed by functions of a layer 1 (e.g., physical layer), a layer 2 (e.g., MAC layer, RLC layer, PDCP layer, etc.), and/or a layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, beam common reference signal, or terminal (or terminal group) specific reference signal (e.g., dedicated reference signal allocated to a terminal (or terminal group)). Here, the common reference signal may be used for channel estimation operations of all terminals located within the corresponding base station or beam coverage (or service area). The dedicated reference signal may be used for a channel estimation operation of a specific terminal or a specific terminal group located within the base station or beam coverage.

Accordingly, when the base station or the beam (e.g., configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication system may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. In a handover procedure, synchronization reconfiguration procedure, or connection reconfiguration procedure, the base station may transmit a dedicated control message including the configuration information of the common reference signal to the terminal.

The configured beam information may include at least one of a configured beam index (or identifier), configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and reference signal identifier.

In the present disclosure, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, MAC message, and PHY message, and may identify a base station with which the terminal performs a beam monitoring operation, radio access operation, and/or control (or data) packet transmission and reception operation.

The result of the measurement operation (e.g., beam monitoring operation) for the beam may be reported through a physical layer control channel (e.g., PUCCH) and/or a MAC message (e.g., MAC CE, control PDU). Here, the result of the beam monitoring operation may be a measurement result for one or more beams (or beam groups). For example, the result of the beam monitoring operation may be a measurement result for beams (or beam groups) according to a beam sweeping operation of the base station.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam, a change from the deactivated beam to the active beam, a change from the primary beam to the secondary beam, a change from the secondary beam to the primary beam, a change from the primary beam to the reserved (or candidate) beam, or a change from the reserved (or candidate) beam to the primary beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more among scheduling information (e.g., radio resource allocation information, modulation and coding scheme (MCS) information), feedback information (e.g., channel quality indication (CQI), precoding matrix indicator (PMI), HARQ ACK, HARQ NACK), resource request information (e.g., scheduling request (SR)), result of the beam monitoring operation for supporting beamforming functions, TCI state ID, and measurement information for the active beam (or deactivated beam).

The physical layer control channel may be configured to be transmitted through the primary beam of downlink. In this case, the feedback information may be transmitted and received through the primary beam, and data scheduled by the control information may be transmitted and received through the secondary beam. The physical layer control channel may be configured to be transmitted through the primary beam of uplink. In this case, the resource request information (e.g., SR) and/or the feedback information may be transmitted and received through the primary beam.

In the procedure of allocating the plurality of beams (or the procedure of configuring the TCI states), the allocated (or configured) beam indexes, information indicating a spacing between the beams, and/or information indicating whether contiguous beams are allocated may be transmitted and received through a signaling procedure between the base station and the terminal. The signaling procedure of the beam allocation information may be performed differently according to status information (e.g., movement speed, movement direction, location information) of the terminal and/or the quality of the radio channel. The base station may obtain the status information of the terminal from the terminal. Alternatively, the base station may obtain the status information of the terminal through another method.

The radio resource information may include parameter(s) indicating frequency domain resources (e.g., center frequency, system bandwidth, PRB index, number of PRBs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The condition (e.g., reference value) indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to -noise ratio (SNR), a signal-to-interference ratio (SIR), a signal-to-interference and noise ratio (SINR), or the like.

Meanwhile, in the NR communication system using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth.

Measurement operations (e.g., monitoring operations) for beam (or TCI state) or radio link management may be performed at the base station and/or the terminal. The base station and/or the terminal may perform the measurement operations (e.g., monitoring operations) according to parameter(s) configured for the measurement operations (e.g., monitoring operations). The terminal may report a measurement result according to parameter(s) configured for measurement reporting.

When a reception quality of a reference signal according to the measurement result meets a preconfigured reference value and/or a preconfigured timer condition, the base station may determine whether to perform a beam (or, radio link) management operation, a beam switching operation, or a beam deactivation (or, activation) operation according to a beam blockage situation. When it is determined to perform a specific operation, the base station may transmit a message triggering execution of the specific operation to the terminal. For example, the base station may transmit a control message for instructing the terminal to execute the specific operation to the terminal. The control message may include configuration information of the specific operation.

When a reception quality of a reference signal according to the measurement result meets a preconfigured condition (e.g., reference value or threshold) and/or a preconfigured timer condition, the terminal may report the measurement result to the base station. Alternatively, the terminal may transmit to the base station a control message triggering a beam (or, radio link) management operation, a beam switching operation (or a TCI state ID change operation, a property change operation), or a beam deactivation operation (or a beam activation operation) according to a beam blockage situation. The control message may request to perform a specific operation.

A basic procedure for beam (or TCI state) management through the radio link monitoring may include a beam failure detection (BFD) procedure, a beam recovery (BR) request procedure, and the like for a radio link. An operation of determining whether to perform the beam failure detection procedure and/or the beam recovery request procedure, an operation triggering execution of the beam failure detection procedure and/or the beam recovery request procedure, and a control signaling operation for the beam failure detection procedure and/or the beam recovery request procedure may be performed by one or more of the PHY layer, the MAC layer, and the RRC layer.

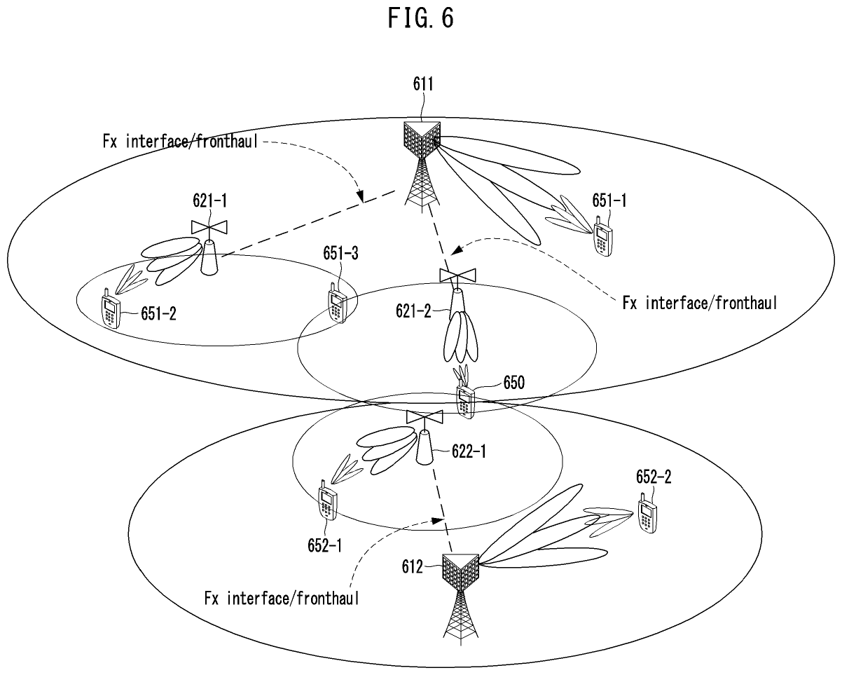

FIG. 6 is a conceptual diagram illustrating a first exemplary embodiment of a method of providing a service using a plurality of radio access points in a communication system.

Referring to FIG. 6, base stations 611 and 612 may provide services to radio access points 621-1, 621-2, and 622-1 within service coverages through wired interfaces or wireless interfaces. Interfaces between the base station 611 and the radio access points 621-1 and 621-2 within the service coverage of the base station 611 may be provided in a wired or wireless manner. An interface between the base station 612 and the radio access point 622-1 within the service coverage of the base station 612 may be provided in a wired or wireless manner. The function split scheme may be applied to the base stations 611 and 612 . In this case, each of the base stations 611 and 612 may be configured as two or more nodes (e.g., CU and DU(s)) that perform radio protocol functions of each of the base stations 611 and 612.

The base stations 611 and 612 and the radio access points 621-1, 621-2, and 622-1 may each provide services to terminals 650, 651-1, 651-2, 651-3, 652-1, and 652-2 within each service coverage through wireless links (e.g., Uu interfaces). Transmission frequencies (or frequency bands) of the radio access points 621-1 and 621-2 within the base station 611 may be the same or different. When the radio access points 621-1 and 621-2 use the same frequency, the radio access points 621-1 and 621-2 may operate as the same cell having the same physical cell ID (PCI) or different cells having different PCIs.

When the radio access points 621-1 and 621-2 operate at the same frequency, the radio access points 621-1 and 621-2 provide a service to the terminal 651-3 in a single frequency network (SFN) scheme. The SFN scheme may refer to a scheme in which one or more radio access points simultaneously transmit the same data to the terminal using the same frequency. In order to provide the SFN scheme-based service, each of the radio access points 621-1 and 621-2 may transmit a downlink channel and/or signal to the terminal 653-1 by using the same resource (e.g., physical resource blocks (PRBs)) in the frequency and time domains. The terminal 653-1 may receive the downlink channel and/or signal from each of the radio access points 621-1 and 621-2 by using a beam (or radio resource) corresponding to a beam identifier (e.g., TCI state identifier) of each of the radio access points 621-1 and 621-2. Here, the expression ‘downlink channel and/or signal’ may refer to at least one of a downlink channel and a downlink signal. The TCI state identifier may refer to a TCI state ID or a TCI state index.

The radio access points 621-1 and 621-2 operating at the same frequency may not use the SFN scheme. In this case, each of the radio access points 621-1 and 621-2 may transmit a downlink channel and/or signal to the terminal 651-3 using a different resource (e.g., PRBs) in the frequency and time domains. The terminal 653-1 may receive the downlink channel and/or signal from each of the radio access points 621-1 and 621-2 by using a beam (or radio resource) corresponding to a beam identifier (e.g., TCI state identifier) of each of the radio access points 621-1 and 621-2.

The radio access points 621-1 and 621-2 may have different PCIs. In other words, the radio access points 621-1 and 621-2 may operate as different cells. The fact that the radio access points 621-1 and 621-2 operate as different cells may mean that the base station 611 includes two or more cells having different PCIs, and each of the radio access points 621-1 and 621-2 is a lower node (or radio access point) of a cell corresponding thereto. Alternatively, the fact that the radio access points 621-1 and 621-2 operate as different cells may mean that two or more cells having different PCIs exist within one DU included in the base station 611 to which the function split scheme is applied, and each of the radio access points 621-1 and 621-2 is a lower node (or radio access point) of a cell corresponding thereto.

When the radio access points 621-1 and 621-2 belong to different cells within a base station or a DU of the base station, a service for a terminal (e.g., terminal in the RRC connected state) that does not support carrier aggregation functions may be provided by one radio access point.

The base station may provide a service to a terminal using one or more cells or one or more radio access points. The base station to which the function split scheme is applied may include one CU and a plurality of DUs, and each of the plurality of DUs may provide a service to a terminal using one or more cells or one or more radio access points.

In the exemplary embodiment of FIG. 5, the UPF 540 may exchange user plane traffic packets with the base station 510 of the RAN using an NG-U interface of a backhaul. The AMF 540 may exchange control plane signaling and/or control messages with the base station 510 of the RAN using an NG-C interface of the backhaul. The UPF 540 may be a node (e.g., entity) belonging to the core network. The UPF 540 may be in charge of a mobility anchoring function and/or a packet data unit (PDU) handling function. The UPF 540 may perform the following function(s).
Anchor point for intra-RAT mobility and/or inter-RAT mobility
Packet routing and/or forwarding
Uplink classifier for supporting traffic flow routing
Branch point for multi-homed PDU sessions
QoS handling for user plane (e.g., packet filtering, gating, UL/DL rate enforcement)
Verification of uplink traffic
Service data flow (SDF)-to-QoS flow mapping

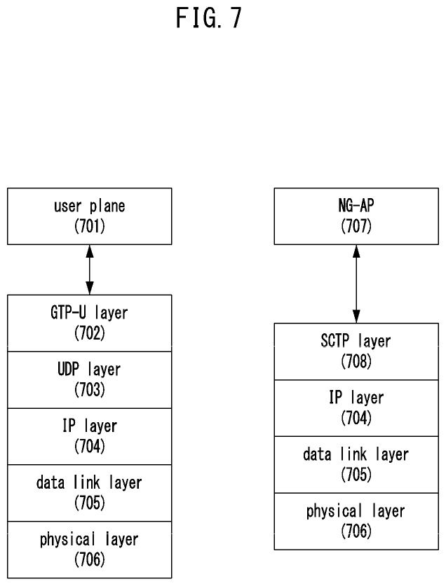

FIG. 7 is a conceptual diagram illustrating a first exemplary embodiment of a protocol structure of a user plane interface (e.g., NG-U interface) and a control plane interface (e.g., NG-C interface) of a UPF.

Referring to FIG. 7, a protocol stack of a user plane interface (e.g., NG-U interface) between a UPF and a RAN node (e.g., base station) may include a physical layer 706, data link layer 705, internet protocol (IP) layer 704, user datagram protocol (UDP) layer 703, and general packet radio service (GPRS) tunneling protocol (GTP)-U layer 702. The IP layer 704 may perform a forwarding function of IP packets. The protocol stack of the NG-U interface may transmit PDU(s) for a user plane 701 between an NG-RAN node and the UPF.

A protocol stack of a control plane interface (e.g., NG-C interface) between an AMF and the RAN node (e.g., NG-RAN node) may include the physical layer 706, the data link layer 705, IP layer 704, and S common transport protocol (SCTP) layer 708. To ensure transmission reliability of signaling messages, the SCTP layer 708 may be located on top of the IP layer 704. The SCTP layer 708 may deliver a signaling PDU of an NG-application protocol (NG-AP) 707 for an application layer to the IP layer 704 in a point-to-point manner.

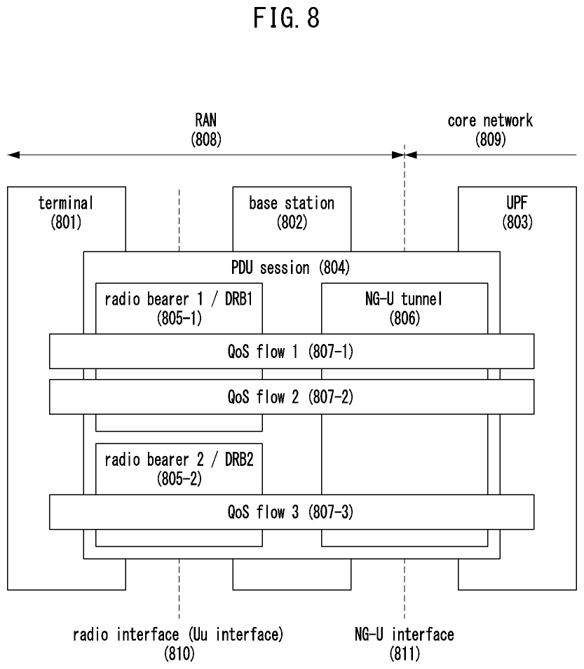

FIG. 8 is a conceptual diagram illustrating a first exemplary embodiment of QoS flow mapping between nodes for QoS handling in a communication system.

Referring to FIG. 8, a communication system may include a RAN 808 and a core network 809. A QoS model in the communication system may support guaranteed bit rate (GBR) QoS flow(s) and non-GBR QoS flow(s) with respect to QoS flows. In a non-access stratum (NAS) level, a QoS differentiation operation or a QoS classification operation for traffic constituting one PDU session may be performed on a QoS flow basis. For example, the QoS flows may be classified into a QoS flow 1 807-1, QoS flow 2 807-2, and QoS flow 3 807-3. The QoS flow may be identified within a PDU session 804 using a QoS flow identifier (QFI) delivered through an encapsulation header in the NG-U interface.

The terminal 801 may establish one or more PDU sessions 804 with a UPF 803 that is a node of the core network 809. Information on the PDU session 804 established for the terminal 801 may be delivered to a base station 802 of the RAN 808 using an NG-U tunnel 806 for an NG-U interface 811. To exchange traffic packets through a radio interface 810, the base station 802 and the terminal 801 may establish radio bearers 805-1 and/or 805-2. The radio interface 810 may be a Uu interface. The radio bearers 805-1 and/or 805-2 may be classified into a data radio bearer (DRB) for delivery of traffic packets and a signaling radio bearer (SRB) for delivery of signaling messages.

One PDU session 804 may include one or more radio bearers 805-1 and/or 805-2. One radio bearer (805-1 or 805-2) may deliver traffic packets for one or more QoS flows. For example, a radio bearer 1 (e.g., DRB1) 805-1 may be configured to be mapped to two QoS flows 807-1 and 807-2. A radio bearer 2 (e.g., DRB2) 805-2 may be configured to be mapped to one QoS flow 807-3. The base station 802 may transmit packets to the terminal 801 by multiplexing the two QoS flows 807-1 and 807-2 belonging to the one PDU session 804 in the one DRB1 805-1.

When two PDU sessions are established between the terminal 801 and the UPF 803, packets belonging to different PDU sessions may be delivered using different DRBs based on the above-described method.

The RAN 808 and the core network 809 may guarantee a delivery quality (e.g., reliability, delay, etc.) of traffic packets required by service attributes through appropriate QoS flow-DRB mapping based on definition, policy, and/or QFI-based QoS classification rules in the system. A mapping operation may be divided into a first step of mapping an IP flow to a QoS flow in a NAS domain and a second step of mapping a QoS flow to a DRB in an access stratum (AS) domain. In the terminal 801 and the core network 809 (e.g., UPF 803), a packet filter at the NAS level may be configured such that uplink (UL) packets and downlink (DL) packets have an association or mapping relationship with a QoS flow. An AS-level mapping rule between the terminal 801 and the base station 802 may be configuring a UL QoS flow and/or DL QoS flow to have an association or correspondence relationship with a DRB.

The size of a terminal for XR service and/or cloud gaming service provision may be small, and the battery capacity of the terminal may be limited. XR service video packets may be generated based on a moving picture experts group (MPEG) scheme. When the MPEG scheme is used, a compression method using a frame-by-frame compression operation and/or correlation between frames may be applied. A motion compression scheme may be applied to remove redundancy of video sequences in the time domain. When the motion compression scheme is used, I-frames, P-frames, and B-frames may be used to efficiently transmit differences between successive frames.

Each of I-frame, P-frame, and B-frame may be data or information. In the present disclosure, a transmission/reception operation of I-frame may refer to a transmission/reception operation of first data or first information, a transmission/reception operation of P-frame may refer to a transmission/reception operation of second data or second information, and a transmission/reception operation of B-frame may refer to a transmission/reception operation of third data or third information. In other words, a method for transmitting and receiving I-frame, P-frame, and/or B-frame in the present disclosure may be applied to transmission and reception operations of data and/or information. The first data, second data, and third data may have different levels of importance (e.g., different priorities). For example, the importance (e.g., priority) of the first data may be the highest, and the importance (e.g., priority) of the third data may be the lowest. The first information, second information, and third information may have different levels of importance (e.g., different priorities). For example, the importance (e.g., priority) of the first information may be the highest, and the importance (e.g., priority) of the third information may be the lowest.

An I-frame may be a frame compressed in units of a single frame. For example, the I-frame may be compressed based on a joint photographic experts group (JPEG) scheme. Motion for an I-frame may be predicted based on a previous I-frame, and a discrete cosine transform (DCT) operation for the remaining difference may be performed. A frame obtained by compressing a result of the DCT operation may be a P-frame. A B-frame may be a frame generated based on a bi-directional prediction technique of referring to a subsequent frame as well as a previous frame. In the B-frame, dependence on previous and subsequent frames may be high. A basic principle of video compression is to record only information (e.g., motion) on a changed part when a frame is changed.

When an I-frame for a traffic packet of an MPEG-based video is not detected, a receiving node may not be able to identify a key frame, which is a reference for restoring (or reproducing) a compressed video. In this case, the receiving node may not be able to restore the compressed video. An MPEG-based video traffic packet may be referred to as ‘video packet’. In the present disclosure, each of the video packet, traffic packet, and IP packet may mean data, data unit, or information (e.g., information element).

A video packet may be generated in units of a group of pictures (GOP) consisting of to 15 frames so that a frame can be quickly restored at any point in the video. The receiving node (e.g., restoration function block) may identify an I-frame within a GOP through a sequence header of a front part of the GOP, and may restore the video by referring to the I-frame.

In order to efficiently provide an XR service in the communication system, I-frames and P-frames within a video packet may be classified in the core network and/or the radio access network, and a QoS priority of I-frames may be set higher than that of P-frames. In other words, a transmission reliability of I-frames may be improved. To support the above-described operation, a QoS handling method and/or radio bearer management method may be required. According to the QoS handling method and/or radio bearer management method, radio resources of the RAN can be efficiently used.

The core network (e.g., node(s) belonging to the core network) and/or the RAN (e.g., node(s) belonging to the RAN) may distinguish I-frame(s) and P-frame(s) of a video packet.

As a first method, a node of the core network and/or RAN may distinguish I-frame(s) and P-frame(s) of the video packet in the QoS flow mapping procedure. The UPF of the core network and/or a peer entity of the terminal may distinguish between I-frame(s) and P-frame(s) in the QoS flow mapping procedure. The peer entity of the terminal may mean a NAS layer entity (e.g., NAS functional block) of the terminal that performs a UL QoS flow mapping function for video packets of a PDU session established for the core network.

The QoS flow mapping procedure may be performed to support a user plane QoS handling function. The UPF and/or the peer entity of terminal may identify an IP packet and/or video packet (e.g., video packet within the IP packet) within the established PDU session in the QoS flow mapping procedure, and distinguish (e.g., classify) I-frame(s) and P-frame(s) in the IP packet and/or video packet. The identifying of the IP packet within the PDU session by the UPF and/or the peer entity of the terminal may mean that the UPF and/or the peer entity of the terminal detects (or extracts) parameter values of fields of a header in the IP packet, and/or may mean that the UPF and/or the peer entity of the terminal detects an IP payload using the detected IP header information.

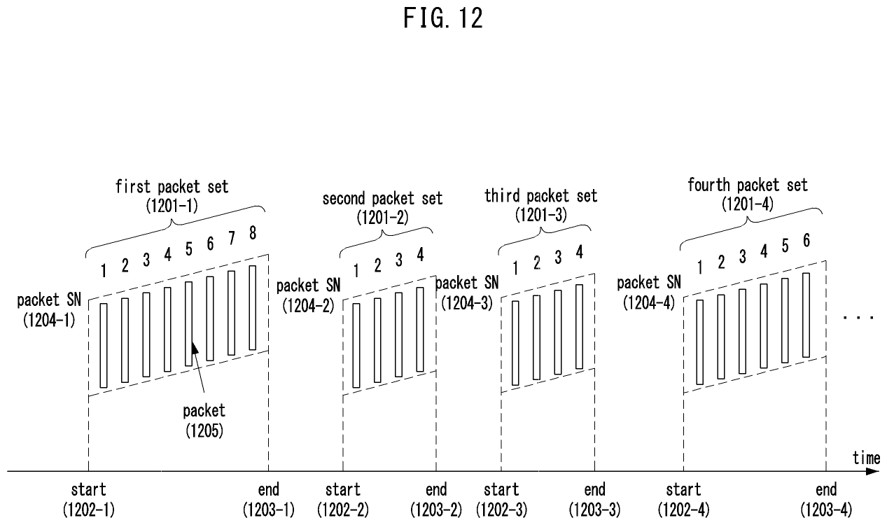

The identifying of the video packet within the IP packet by the UPF and/or the peer entity of the terminal may mean that the UPF and/or the peer entity of the terminal performs searching in units of a GOP (or, in units of a packet (or packet set) constituting the GOP shown in FIG. 12) based on a sequence header (or, packet set configuration information shown in FIG. 12) of the GOP constituting the video packet. The UPF and/or the peer entity of the terminal may classify the video packet within the PDU session into I-frame(s) and P-frame(s) by performing the identification operation (or search operation, detection operation) on the IP packet, IP payload, or video packet. The identification operation may be performed on a packet or frame basis.

After the video packet is classified into I-frame(s) and P-frame(s) in the PDU session, the UPF and/or the peer entity of the terminal may map the I-frame(s) and P-frame(s) to different QoS flows, and transmit the I-frame(s) and P-frame(s) to the base station through the different QoS flows.

A QoS flow-to-DRB mapping procedure may be performed in a service data adaptation protocol (SDAP) layer of the node (e.g., base station, terminal) of the RAB, and in the QoS flow-to-DRB mapping procedure, the I-frame(s) and the P-frame(s) may be distinguished. The SDAP layer may belong to a radio access protocol stack of the user plane.

An SDAP entity may be configured for each PDU session in the base station and/or terminal. The SDAP entity may perform the QoS flow-to-DRB mapping procedure. The SDAP entity may refer to the SDAP layer or a node performing the SDAP function. The SDAP entity of the base station may mark a QoS flow identifier on a downlink packet. The SDAP entity of the terminal may mark a QoS flow identifier on an uplink packet.

The SDAP entity of the terminal and/or the base station, which is configured in the PDU session establishment procedure for video service between the terminal and the UPF, may perform the operation of distinguishing I-frame(s) and P-frame(s). The SDAP entity configured for the PDU session of video service may identify QoS flows constituting the PDU session, and distinguish (e.g., classify) I-frame(s) and P-frame(s) based on the identified QoS flows. The SDAP entity may deliver the I-frame(s) and the P-frame(s) to a packet data convergence protocol (PDCP) layer using different DRBs.

Identically or similarly to the method for the UPF of the core network to identify the IP packet and/or video packet, the identification of QoS flows and the classification of I-frame(s) and P-frame(s) based thereon by the SDAP entity may mean that the SDAP entity detects (or extracts) parameter values in fields of a header of an IP packet within an SDAP SDU, that the SDAP entity detects an IP payload using detected IP header information, and/or that the SDAP entity classifies I-frame(s) and P-frame(s) of the video packet based on a sequence header of the GOP (or, packet set configuration information shown in FIG. 12) constituting the video packet within the IP payload.

The SDAP entity of the base station and/or terminal may classify the SDAP SDU into I-frame(s) and P-frame(s). Thereafter, the SDAP entity of the base station and/or terminal may generate an SDAP PDU and deliver the SDAP PDU to a PDCP layer (e.g., PDCP entity).

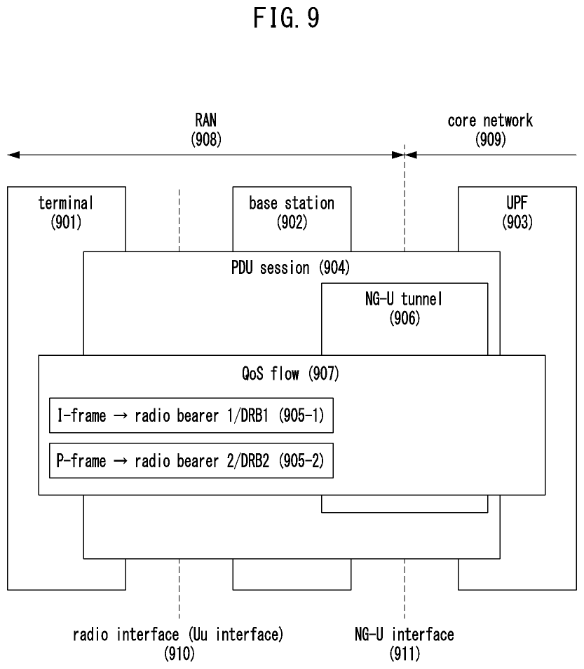

FIG. 9 is a conceptual diagram illustrating a first exemplary embodiment of a method for mapping I-frame(s) and P-frame(s) in a communication system.

Referring to FIG. 9, a base station and/or a terminal may classify a video packet into I-frame(s) and P-frame(s). In other words, a video packet within a PDU session 904 may be classified into I-frame(s) and P-frame(s). The I-frame(s) and P-frame(s) may be mapped to QoS flows and/or radio bearers, respectively. For a video service, the PDU session 904 may be established between a terminal 901, base station 902, and UPF 903. The video packet may be delivered using a QoS flow 907 constituting the PDU session 904.

An SDAP entity of the terminal 901 and/or the base station 902 may classify the video packet (e.g., SDAP SDU) into I-frame(s) and P-frame(s). The SDAP entity of the terminal 901 and/or the base station 902 may generate an SDAP PDU1 including I-frame(s), map the SDAP PDU1 (e.g., I-frame(s)) to a DRB1 905-1, and deliver the SDAP PDU1 (e.g., I-frame(s)) to a PDCP layer by using the DRB1 905-1. The SDAP entity of the terminal 901 and/or the base station 902 may generate an SDAP PDU2 including P-frame(s), map the SDAP PDU2 (e.g., P-frame(s)) to a DRB2 905-2, and deliver the SDAP PDU2 (e.g., P-frame(s)) to the PDCP layer by using the DRB2 905-2.

One QoS flow may be mapped to two or more DRBs. A QoS flow-to-DRB mapping method may be limited to being applied to when I-frame(s) and P-frame(s) are classified within a PDU session established for video service provision. In other words, the QoS flow-to-DRB mapping operation in the SDAP entity according to the exemplary embodiment of FIG. 9 may be configured to be performed when I-frame(s) and P-frame(s) are classified for QoS handling and/or radio bearer management of the PDU session in the communication system. When the communication system does not allow (or configure) the QoS flow-to-DRB mapping operation to be performed in the SDAP entity according to the exemplary embodiment of FIG. 9, the terminal, base station, and/or UPF may perform the QoS flow-to-DRB mapping operation according to the exemplary embodiment of FIG. 8.

As a second method, a node of the core network and/or RAN may distinguish between I-frame(s) and P-frame(s) based on the size of a video packet of a PDU session.

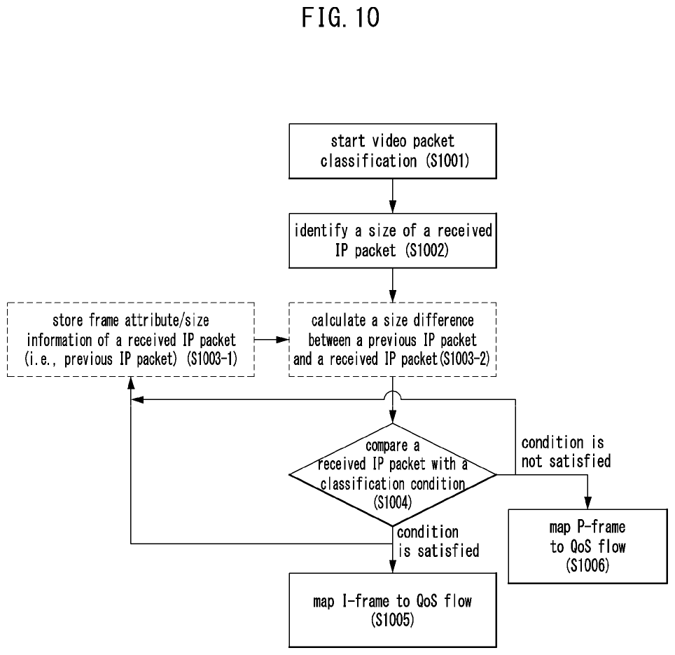

FIG. 10 is a sequence chart illustrating a first exemplary embodiment of a method for distinguishing I-frame(s) and P-frame(s) in a communication system.

Referring to FIG. 10, I-frame(s) and P-frame(s) may be classified based on the size of the packet (e.g., video packet). A condition for classifying a video packet of a PDU session into I-frame(s) or P-frame(s) may be at least one of the following conditions. The conditions below may be conditions for video packet (e.g., IP packet) classification. A packet may mean a video packet and/or an IP packet.
Condition 1: Condition based on a preset packet size.
Condition 2: Condition based on a frame attribute of a previous packet and/or a packet size difference between the previous packet and a current packet (e.g., received packet)
Condition 3: Condition that combines Condition 1 and Condition 2.

The UPF of the core network, peer entity of the terminal, SDAP entity of the terminal, and/or SDAP entity of the base station may perform a method of distinguishing I-frame and P-frame based on a packet size.

A method of distinguishing I-frame and P-frame based on a packet size, which is performed by the UPF of the core network and/or peer entity of the terminal will be described. In the present disclosure, the UPF may mean a UPF of the core network, and the peer entity may mean a peer entity of the terminal. When a PDU session for XR service provision is established between the terminal, base station, and UPF, the UPF and/or peer entity may start a packet classification operation for classifying a video packet of the PDU session into I-frame and P-frame based on the above-described condition (e.g., Condition 1, 2, and/or 3) (S1001). When a video packet is generated, the UPF and/or peer entity may perform the step S1001.

When a video packet classification condition is set to Condition 1, the UPF and/or peer entity may set a classification condition and/or a classification condition value for a step S1004 to a preset packet size in the step S1001.

The classification condition may be configured to be satisfied when the size of the IP packet identified in a step S1002 exceeds the packet classification condition value. Alternatively, the classification condition may be configured to be satisfied when the size of the IP packet identified in the step S1002 is greater than or equal to the packet classification condition value.

The classification condition value may be set differently depending on whether an IP payload for a video packet is fragmented. For example, when a video packet is fragmented, the packet classification condition value may be set to information on whether a video packet is fragmented or the number N of fragments of the fragmented IP packet. When a video packet is not fragmented, the packet classification condition value may be set to M bytes in consideration of the maximum IP payload size allowed in the communication system. Each of N and M may be a natural number.

The UPF or peer entity may identify the size of an IP packet to be delivered using a QoS flow in the PDU session established for video service (S1002). Here, the IP packet may mean a received IP packet and/or a current IP packet. In the step S1002, the UPF and/or the peer entity may identify whether the IP packet to be delivered using the QoS flow is fragmented, the number n of the fragments of the IP packet, and/or the size of the IP packet. The size of the IP packet may be expressed as m bytes. Each of n and m may be a natural number.

The UPF and/or the peer entity may compare the IP packet identified in the step S1002 and the classification condition value according to the packet classification condition configured in the step S1001 (S1004). In the step S1004, the size of the IP packet or the number of fragments of the fragmented IP packet may be compared with the classification condition value. For example, the packet classification condition value may be set to the number N of fragments of the fragmented IP packet, and the condition may be configured to be satisfied when the number of fragments of the IP packet is greater than the packet classification condition value. Here, N may be 1.

When the IP packet identified in the step S1002 is not fragmented or when the number of fragments of the fragmented IP packet identified in th step S1002 is 1, the UPF and/or peer entity may determine that the condition is not satisfied in the step S1004, and may classify the IP packet that does not satisfy the condition as a P-frame. In other words, the UPF and/or peer entity may determine an IP packet that does not satisfy the condition as a P-frame. When the number of fragments of the fragmented IP packet identified the step S1002 is 2 or more, the UPF and/or peer entity may determine that the condition is satisfied in the step S1004, and may classify the IP packet that satisfies the condition as an I-frame. In other words, the UPF and/or peer entity may determine an IP packet that satisfies the condition as an I-frame.

In the step S1001, the packet classification condition value may be set to an IP packet size (e.g., M bytes), and the condition may be configured to be satisfied when the size of a received IP packet is greater than M bytes. Here, M may be 1000. If the size of the IP packet identified in the step S1002 is 1000 bytes or less, in the step S1004, the UPF and/or the peer entity may determine that the condition is not satisfied, and classify the IP packet that does not satisfy the condition as a P-frame. In other words, the UPF and/or peer entity may determine an IP packet that does not satisfy the condition as a P-frame. If the size of the IP packet identified in the step S1002 exceeds 1000 bytes, in the step S1004, the UPF and/or the peer entity may determine that the condition is satisfied, and classify the IP packet that satisfies the condition as an I-frame. In other words, the UPF and/or peer entity may determine an IP packet that satisfies the condition as an I-frame.

The UPF and/or the peer entity may map the I-frame (e.g., IP packet) determined to satisfy the condition in the step S1004 to a QoS flow for I-frame (S1005). Referring to FIG. 9, in the step S1005, the I-frame may be mapped to the DRB1 905-1 in the QoS flow. The UPF and/or peer entity may map a P-frame (e.g., IP packet) determined to be unsatisfactory in the step S1004 to another QoS flow (e.g., QoS flow for P-frame) (S1006). Referring to FIG. 9, in the step S1006, the P-frame may be mapped to the DRB2 905-2 in the QoS flow.

When the video packet classification condition is set to Condition 2, the UPF and/or peer entity may set a classification condition and/or a classification condition value for the step S1004 to a preset packet size difference in the step S1001. When Condition 2 is used, the classification condition ‘packet size difference’ may mean a size difference between the current IP packet and the previous IP packet (e.g., the IP packet immediately preceding the current IP packet) according to a sequence of the IP packets (e.g., ordered sequence). For example, the packet size difference may mean a size difference between an IP packet having an IP sequence 1 and an IP packet having an IP sequence 2.

When the classification condition is set to Condition 2, a frame attribute (e.g., I-frame or P-frame) of the previous IP packet and/or size information of the previous IP packet may be set to a default value, null, or 0.

The classification condition may be configured to be satisfied when the size difference between the IP packets identified in a step S1003-2 exceeds the packet classification condition value or when the size difference between the IP packets identified in the step S1003-2 is greater than or equal to the packet classification condition value.

The classification condition value may be set differently depending on whether an IP payload for a video packet is fragmented. For example, when a video packet (e.g., IP payload) is fragmented, the classification condition value may be set to information on whether a video packet is fragmented or the number N of fragments of the fragmented IP packet. When a video packet (e.g., IP payload) is not fragmented, the classification condition value may be set to M bytes in consideration of the maximum IP payload size allowed in the communication system. Each of N and M may be a natural number.

The UPF and/or peer entity may identify the size of an IP packet to be delivered using a QoS flow in a PDU session established for video service (S1002). In the step S1002, the UPF and/or the peer entity may identify whether the IP packet to be delivered using the QoS flow is fragmented, the number n of fragments of the fragmented IP packet, and/or the size of the IP packet. The size of the IP packet may be expressed as m bytes. Each of n and m may be a natural number.

The UPF and/or peer entity may calculate a size difference between the IP packets by comparing the size of the IP packet identified in the step S1002 with the size of the previous IP packet stored in the step S1003-1 (S1003-2).

The UPF and/or the peer entity may compare the size difference between the IP packets identified in the step S1003-2 and/or the classification condition value for the frame attribute of the previous IP packet according to the classification condition set in the step S1001 (S1004).

For example, the condition may be configured to be satisfied when the classification condition value is set to M bytes in the step S1001 and the size difference between the IP packets exceeds the classification condition value. Here, M may be 1400. In this case, if the size difference between the IP packets calculated in the step S1003-2 exceeds 1400 bytes, the UPF and/or peer entity may determine that the condition is satisfied, and classify the IP packet that satisfies the condition as an I-frame. In other words, the UPF and/or peer entity may determine the IP packet that satisfies the condition as an I-frame. If the size difference between the IP packets calculated in the step S1003-2 is 1400 bytes or less, the UPF and/or the peer entity may determine that the condition is not satisfied, and classify the IP packet that does not satisfy the condition as a P-frame. In other words, the UPF and/or peer entity may determine the IP packet that does not satisfy the condition as a P-frame.

When the video packet classification condition is set to Condition 2, the UPF and/or peer entity may additionally consider the frame attribute of the previous IP packet. A classification condition value 1 for the size difference between the IP packets when the frame attribute of the previous IP packet is I-frame may be set independently of a classification condition value 2 for the size difference between the IP packets when the frame attribute of the previous IP packet is P-frame. In this case, two classification condition values may be set. Even when Condition 2 is used and the frame attribute of the previous IP packet is additionally considered, only one classification condition value may be set, or the two classification condition values (e.g., classification condition value 1 and classification condition value 2) may be set to the same value.

For example, when the frame attribute of the previous IP packet is I-frame, and the difference between the size of the IP packet identified in the step S1002 and the size of the previous IP packet stored in the step S1003-1 exceeds or is equal to or greater than the classification condition value 1, the UPF and/or the peer entity may classify the IP packet as an I-frame. When the frame attribute of the previous IP packet is I-frame, and the difference between the size of the IP packet identified in the step S1002 and the size of the previous IP packet stored in the step S1003-1 is less than or equal to the classification condition value 1, the UPF and/or peer entity may classify the IP packet as a P-frame.

In the step S1001, the IP packet size difference, which is the classification condition value, may be configured as information on whether the IP packet is fragmented. In this case, the step S1003-2 (e.g., the step of calculating the size difference between the IP packets) may be omitted.

When the IP packet size difference is configured as information on whether the IP packet is fragmented, the UPF and/or peer entity may classify the fragmented IP packet as an I-frame, and classify the non-fragmented IP packet as a P-frame.

The UPF and/or peer entity may store information of the size of the IP packet identified in the step S1004 and/or information on the frame attribute (e.g., I-frame or P-frame) of the IP packet (S1003-1).

The UPF and/or the peer entity may map the I-frame (e.g., IP packet) determined to satisfy the condition in the step S1004 to a QoS flow for I-frame (S1005). Referring to FIG. 9, the I-frame may be mapped to the DRB1 905-1 in the QoS flow 907. The UPF and/or peer entity may map the P-frame (e.g., IP packet) determined not to satisfy the condition in the step S1004 to another QoS flow (e.g., QoS flow for P-frame) (S1006). Referring to FIG. 9, the P-frame may be mapped to the DRB2 905-2 in the QoS flow 907.

When the video packet classification condition is set to Condition 3, the UPF and/or the peer entity may set a classification condition and/or a classification condition value according to Condition 1 and Condition 2 described above. In addition, the UPF and/or the peer entity may classify the IP packet into I-frame(s) or P-frame(s) by performing a combination of one or more of the steps of S1001 to S1004.

The UPF and/or the peer entity may classify the IP packet into an I-frame or a P-frame according to Condition 3, may map the I-frame into a QoS flow (e.g., DRB1 805-1 in the QoS flow 907) in the step S1005, and may map the P-frame into a QoS flow (e.g., DRB2 805-2 in the QoS flow 907) in the step S1006.

After classifying the IP packet (e.g., video packet) within the PDU session into I-frame and P-frame based on the size of the IP packet, the UPF and/or peer entity may map the I-frame and the P-frame to different QoS flows, and transmit the I-frame and P-frame to the base station through different QoS flows. The I-frame and the P-frame may be transmitted through different DRBs.

The method of distinguishing I-frame and P-frame based on the size of the IP packet may be performed by the SDAP layer (e.g., SDAP entity). The SDAP entity may mean an SDAP entity of the terminal and/or base station. The SDAP entity may classify an SDAP SDU for a QoS flow corresponding to the PDU session established for the video service into I-frame and P-frame based on the procedure of FIG. 10 described above. In other words, the SDAP entity may classify the IP packet into I-frame and P-frame based on the size of the IP packet.

The SDAP entity may classify the SDAP SDU mapped to the QoS flow of the PDU session for video service into I-frame and P-frame according to the above-described classification condition (e.g., Condition 1, Condition 2, or Condition 3). In other words, in the step S1001, the SDAP entity may start the operation of classifying the SDAP SDU.

When the classification condition of video packet (e.g., SDAP SDU) is set to Condition 1, the SDAP entity may set a classification condition and/or a classification condition value for the step S1004 to a preset packet size in the step S1001.

The classification condition may be configured to be satisfied when the size of the SDAP SDU identified in the step S1002 exceeds the packet classification condition value. Alternatively, the classification condition may be configured to be satisfied when the size of the SDAP SDU identified in the step S1002 is equal to or greater than the packet classification condition value. In the SDAP entity, the classification condition value may be set to M bytes in consideration of the maximum IP payload size allowed in the communication system.

The SDAP entity may identify the size of an SDAP SDU to be delivered using a QoS flow in the PDU session established for video service (S1002). The size of the IP packet may be expressed as m bytes, and m may be a natural number.

The SDAP entity may compare the size of the SDAP SDU identified in the step S1002 with the classification condition value according to the packet classification condition set in the step S1001 (S1004).

In the step S1001, the packet classification condition value may be set as an SDAP SDU size (e.g., M bytes), and the condition may be configured to be satisfied when the size of the received SDAP SDU is greater than M bytes. Here, M may be 1000. If the size of the SDAP SDU identified in the step S1002 is 1000 bytes or less, in the step S1004, the SDAP entity may determine that the condition is not satisfied and classify the SDAP SDU that does not satisfy the condition as a P-frame. In other words, the SDAP entity may determine the SDAP SDU that does not satisfy the condition as a P-frame. If the size of the SDAP SDU identified in the step S1002 exceeds 1000 bytes, in the step S1004, the SDAP entity may determine that the SDAP SDU satisfies the condition, and the SDAP entity may determine the SDAP SDU that satisfies the condition as an I-frame. In other words, the SDAP entity may determine the SDAP SDU that satisfies the condition as an I-frame.

The SDAP entity may map the I-frame (e.g., SDAP SDU) determined to satisfy the condition in the step S1004 to the DRB for I-frame (S1005). Referring to FIG. 9, the I-frame may be mapped to the DRB1 905-1. The SDAP entity may map the P-frame (e.g., SDAP SDU) determined to be unsatisfactory in the step S1004 to another DRB (e.g., DRB for P-frame) (S1006). Referring to FIG. 9, the P-frame may be mapped to the DRB2 905-2.

When the video packet classification condition is set to Condition 2, the SDAP entity may set a classification condition and/or a packet classification condition value for the step S1004 to a preset packet size difference in the step S1001. When Condition 2 is used, the classification condition ‘packet size difference’ may mean a size difference between the current SDAP SDU (or current IP packet) and the previous SDAP SDU (or previous IP packet) according to a sequence of the SDAP SDUs (e.g., IP packets). The previous SDAP SDU may refer to the SDAP SDU immediately preceding the current SDAP SDU.

When the classification condition is set to Condition 2, a frame attribute (e.g., I-frame or P-frame) of the previous SDAP SDU and/or information on the size of the previous SDAP SDU may be set to a default value, null, or 0.

The classification condition may be configured to be satisfied when the size difference between the SDAP SDUs identified in the step S1003-2 exceeds the packet classification condition value or when the size difference between the SDAP SDUs identified in the step S1003-2 is greater than or equal to the packet classification condition value. The classification condition value may be set to M bytes in consideration of the maximum IP payload size allowed in the communication system.

The SDAP entity may identify the size of an SDAP SDU to be delivered using the QoS flow in the PDU session established for video service (S1002). The size of the SDAP SDU may be expressed as m bytes. m may be a natural number.

The SDAP entity may calculate a size difference between the SDAP SDUs by comparing the size of the SDAP SDU identified in the step S1002 with the size of the previous SDAP SDU stored in the step S1003-1 (S1003-2).

The SDAP entity may compare the size difference between the SDAP SDUs identified in the step S1003-2 and/or the classification condition value according to the frame attribute of the previous SDAP SDU according to the classification condition set in the step S1001 (S1004).

For example, the condition may be configured to be satisfied when the classification condition value in the step S1001 is set to M bytes and the size difference between the SDAP SDUs exceeds the classification condition value. Here, M may be 1400. In this case, if the size difference between the SDAP SDUs calculated in the step S1003-2 exceeds 1400 bytes, the SDAP entity may determine that the condition is satisfied, and classify the SDAP SDU satisfying the condition as an I-frame. In other words, the SDAP entity may determine the SDAP SDU that satisfies the condition as an I-frame. If the size difference between the SDAP SDUs calculated in the step S1003-2 is 1400 bytes or less, the SDAP entity may determine that the condition is not satisfied, and classify the SDAP SDU that does not satisfy the condition as a P-frame. In other words, the SDAP entity may determine an SDAP SDU that does not satisfy the condition as a P-frame.

When the video packet classification condition is set to Condition 2, the SDAP entity may additionally consider the frame attribute of the previous SDAP SDU. A classification condition value 1 for the size difference between the SDAP SDUs when the frame attribute of the previous SDAP SDU is I-frame may be set independently of a classification condition value 2 for the size difference between the SDAP SDUs when the frame attribute of the previous SDAP SDU is P-frame. In this case, two classification condition values may be set. Even when Condition 2 is used and the frame attribute of the previous SDAP SDU is additionally considered, only one classification condition value may be set, or the two classification condition values (e.g., classification condition value 1 and classification condition value 2) may be set to the same value.

For example, when the frame attribute of the previous SDAP SDU is I-frame, and the difference between the size of the SDAP SDU identified in the step S1002 and the size of the previous SDAP SDU stored in the step S1003-1 exceeds or is equal to or greater than the classification condition value 1, the SDAP entity may classify the SDAP SDU as an I-frame. When the frame attribute of the previous SDAP SDU is I-frame, and the difference between the size of the SDAP SDU identified in the step S1002 and the size of the previous SDAP SDU stored in the step S1003-1 is less than or equal to the classification condition value 1, the SDAP entity may classify the SDAP SDU as a P-frame.

The SDAP entity may store information of the size of the SDAP SDU identified in the step S1004 and/or information on the frame attribute (e.g., I-frame or P-frame) of the SDAP SDU (S1003-1).

The SDAP entity may map the I-frame (e.g., SDAP SDU of the QoS flow within the PDU session) determined to satisfy the condition in the step S1004 to a DRB for I-frame (S1005). Referring to FIG. 9, the I-frame may be mapped to the DRB1 905-1. The SDAP entity may map the P-frame (e.g., SDAP SDU of the QoS flow within the PDU session) determined not to satisfy the condition in the step S1004 to another DRB (e.g., DRB for P-frame) (S1006). Referring to FIG. 9, the P-frame may be mapped to the DRB2 905-2.

When the classification condition of video packets (e.g., SDAP SDU) is set to Condition 3, the SDAP entity may set a classification condition and/or a classification condition value according to Condition 1 and Condition 2 described above. In addition, the SDAP entity may classify the SDAP SDU into I-frame or P-frame by performing a combination of one or more of the steps of S1001 to S1004. The SDAP SDU may be delivered using the QoS flow corresponding to the PDU session.

The SDAP entity may classify the SDAP SDU into an I-frame or a P-frame according to Condition 3, may map the I-frame into a DRB in the step S1005, and may map the P-frame to a DRB in the step S1006.

After classifying the SDAP SDU into I-frame and P-frame based on the size of the SDAP SDU, the SDAP entity may map the I-frame and the P-frame to different DRBs, and transmit the I-frame and P-frame to the base station through the different DRBs. As in the exemplary embodiment of FIG. 9, for the IP packet (e.g., video packet) delivered using the QoS flow corresponding to the PDU session of video service, the SDAP entity may generate an SDAP PDU for the SDAP SDU classified as an I-frame according to the above-described method, map the SDAP PDU to the DRB1 (e.g., 905-1 of FIG. 9) for I-frame, and deliver the SDAP PDU to the PDCP layer (e.g., PDCP entity) through the DRB1. The SDAP entity may generate an SDAP PDU for the SDAP SDU classified as a P-frame according to the above-described method, map the SDAP PDU to the DRB2 (e.g., 905-2 of FIG. 9) for P-frame, and deliver the SDAP PDU to the PDCP layer (e.g., PDCP entity) through the DRB2.

The IP packets (e.g., traffic packets) for video service may be periodically generated. Low-latency and/or high transmission reliability may be required according to service properties. Accordingly, improvement of radio resource scheduling of a semi-persistent (SPS) scheme and/or a configured grant (CG) scheme may be required. The SPS scheme and/or the CG scheme may be semi-static scheduling schemes. The semi-static scheduling schemes may be distinguished from a dynamic scheduling scheme.

In the SPS scheme and/or the CG scheme, physical layer radio resources may be periodically allocated through RRC parameter configuration. In an initial transmission procedure, a data packet may be transmitted through a physical layer resource (e.g., physical downlink shared channel (PDSCH) or physical uplink shared channel (PUSCH)) allocated in the SPS scheme and/or CG scheme without scheduling information according to a physical layer control channel (e.g., PDCCH or DCI). When retransmission is required according to HARQ feedback information for initial transmission, scheduling information for a physical layer radio resource allocated based on the SPS scheme and/or the CG scheme may be transmitted using a physical layer control channel masked by a dedicated scheduling identifier (e.g., configured scheduling-radio network temporary identifier (CS-RNTI)). The masking operation may refer to a scrambling operation.

When the video service traffic is transmitted using radio resources scheduled by the SPS scheme and/or CG scheme, a delay may increase according to a jitter of the video packets, and radio resources allocated in the SPS scheme and/or CG scheme may be wasted. In the present disclosure, the SPS/CG scheme may mean the SPS scheme and/or the CG scheme, and SPS/CG resource may mean the SPS resource and/or CG resource.

Depending on a frame attribute of a video packet, a DRB for I-frame delivery (hereinafter referred to as ‘DRBi’) may be distinguished from a DRB for P-frame delivery (hereinafter referred to as ‘DRBp’). Packets for video service may be generated periodically, and in order to efficiently deliver the packets through the DRBi or DRBp, a transmission scheme for physical resource blocks (PRBs) of a channel (e.g., PDSCH, PUSCH) allocated by the SPS/CG scheme may be used adaptively. The transmission scheme may mean a modulation and coding scheme (MCS) and/or a HARQ retransmission scheme. The MCS and/or HARQ retransmission scheme may be adaptively adjusted. The adaptive adjustment of the HARQ retransmission scheme may mean limiting the number of HARQ retransmissions and/or controlling whether to perform HARQ retransmission for each HARQ process. HARQ retransmission for each HARQ process may be enabled or disabled.

For example, when packets for DRBi and/or DRBp are transmitted through SPS/CG resources, a transmission scheme using the SPS/CG resources may be determined adaptively according to a radio channel quality between the base station and the terminal and/or the type of the DRB (e.g., DRBi or DRBp). When the adaptive transmission scheme is used, different MCSs may be used, and the HARQ retransmission scheme (e.g., the number of retransmissions, whether or not retransmission is performed for each HARQ process) may be changed. In the adaptive transmission scheme, the MCS applied to DRBi may be set to be more robust than the MCS applied to DRBp. In addition, the number of HARQ retransmissions for DRBi may be set to be greater than the number of HARQ retransmissions for DRBp. HARQ retransmission for DRBi may be enabled, and HARQ retransmission for DRBp may be disabled.

In the adaptive transmission scheme, the MCS may be changed within modulation orders selected from among all modulation orders within an available MCS table. Alternatively, the MCS may be changed within a range of MCS indexes within the available MCS table. For example, when applicable modulation orders within the available MCS table are a quadrature phase shift keying (QPSK), 16 quadrature amplitude modulation (16 QAM), 64 QAM, and 256 QAM, an MCS in SPS/CG configuration parameters may be set to an MCS corresponding to 16 QAM and/or 64 QAM. When MCS indexes within the available MCS table are 0 to 31, the MCS of the SPS/CG configuration parameters configured for DRBi and/or DRBp may be set within a range of contiguous MCS indexes (e.g., MCS indexes 8 to 20) or a range of discrete MCS indexes (e.g., MCS indexes 12 to 14 and 18 to 20).

The terminal and/or the base station may transmit and receive data (e.g., video packets) in the SPS/CG resources by applying different MCSs according to the channel quality and/or the type of the DRB (e.g., DRBi or DRBp) between the terminal and the base station.

The SPS/CG resource allocation for DRBi may be configured to be distinguished from the SPS/CG resource allocation for DRBp. The MCS for DRBi may be set differently from the MCS for DRBp. In this case, the terminal and/or the base station may adaptively select an MCS suitable for a DRB according to the channel quality between the terminal and the base station, and may transmit/receive data (e.g., video packets) using the selected MCS.

In order to adaptively adjust the transmission scheme (e.g., MCS, HARQ retransmission) for DRBi and DRBp for video service, MCS information and/or HARQ retransmission information (hereinafter referred to as ‘XR PRB transmission scheme information’) may be transmitted using at least one of a PDCCH (e.g., DCI) or MAC control element (CE). In other words, the terminal and/or the base station may transmit XR PRB transmission scheme information applied to transmission according to the SPS/CG scheme using a PDCCH and/or MAC CE. The XR PRB transmission scheme information may include at least one of MCS information, modulation order information, or HARQ retransmission information. The MCS information may indicate an MCS value, MCS index, or MCS level. The HARQ retransmission information may indicate enabling or disabling of HARQ retransmission operations for each HARQ process.

A mapping relationship (e.g., correspondence relationship) of the XR PRB transmission scheme information between radio bearers (e.g., DRBi and/or DRBp) and a block (e.g., entity) that performs a baseband function of logical channels, transport channels, and/or physical channels below the MAC layer may be expressed (e.g., indicated) using a DRB identifier, logical channel identifier (LCD), and/or identifier (e.g., process index) of a process performing the above-described function.

For example, the base station may transmit a PDCCH (e.g., DCI) using a scheduling identifier (e.g., xr-RNTI) assigned (e.g., designated) for transmission of SPS/CG configuration information and/or XR PRB transmission scheme information for video service (e.g., XR service). The PDCCH may include the SPS/CG configuration information and/or the XR PRB transmission scheme information. The SPS/CG configuration information may mean SPS/CG configuration parameters. In other words, the base station may transmit the XR PBR transmission scheme information for SPS PDSCH transmission or CG PUSCH transmission using a PDCCH (e.g., DCI) masked by xr-RTNI.

Packets for DRBi/DRBp may be transmitted using SPS/CG resources configured for video service. In this case, for all transmissions using SPS/CG resources for video service (e.g., all transmissions based on the SPS/CG scheme including initial transmission and HARQ retransmission), the base station may transmit scheduling information (e.g., PDSCH allocation information, XR PRB transmission scheme information) using a scheduling identifier (e.g., cell (C)-RNTI, CS-RNTI, or xr-RNTI) assigned to the terminal. The terminal may receive the PDCCH (e.g., DCI) including SPS/CG resource information, and perform a reception operation according to the SPS scheme or a transmission operation according to the CG scheme based on the SPS/CG resource information included in the PDCCH. In other words, the terminal may receive packets for DRBi/DRBp in an SPS resource (e.g., PDSCH). The terminal may transmit packets for DRBi/DRBp in a CG resource (e.g., PUSCH).

An adaptive transmission scheme may be indicated by a MAC CE. When the base station transmits packets for DRBi/DRBp using SPS resources or when the terminal transmits packets for DRBi/DRBp using CG resources, the XR PRB transmission scheme information may be transmitted through a MAC CE. In other words, the MAC CE may include the XR PRB transmission scheme information. A separate logical channel identifier (LCD) for the MAC CE used for transmission of XR PRB transmission scheme information for SPS/CG resources may be assigned. The MAC CE may be distinguished by the separate LCD. The XR PRB transmission scheme information transmitted through the MAC CE may include at least one of an MCS index, modulation order, indicator (e.g., bitmap) indicating an MCS index and/or modulation order, or HARQ retransmission information. The HARQ retransmission scheme may be changed by HARQ retransmission information (e.g., HARQ retransmission configuration parameter) included in the XR PRB transmission scheme information.

When transmission according to the SPS/CG scheme is performed based on the adaptive transmission scheme, the base station and/or terminal may apply the received XR PRB transmission scheme information (e.g., MCS index, modulation order, and/or HARQ retransmission information) equally until reception of the next (or different) XR PRB transmission scheme information.

In order to efficiently deliver video packets, a hybrid scheduling scheme may be considered. The hybrid scheduling scheme may include feature(s) of the dynamic scheduling scheme and the SPS/CG scheduling scheme. For example, in an initial transmission procedure (e.g., video packet initial transmission procedure), the base station may transmit resource allocation information using the dynamic scheduling scheme. In other words, in the initial transmission procedure, the base station may transmit the resource allocation information through a PDCCH masked by a scheduling identifier (e.g., C-RTNI) assigned to the terminal. In a retransmission procedure (e.g., video packet retransmission procedure), the base station may transmit resource allocation information using the SPS/CG scheduling scheme. In other words, the base station may transmit resource allocation information (e.g., scheduling information) using RRC parameter(s) and/or MAC parameter(s). The initial transmission procedure may mean an initial transmission/reception procedure, and the retransmission procedure may mean a re-transmission/reception procedure.

The above-described scheme may be an advanced SPS/CG scheme. The advanced SPS may be referred to as ‘AdvSPS’, and the advanced CG may be referred to as ‘AdvCG’. In the present disclosure, AdvSPS may mean DL AdvSPS, and AdvCG may mean UL AdvCG. AdvSPS/AdvCG may mean AdvSPS and/or AdvCG. Accordingly, AdvSPS/AdvCG resources may refer to AdvSPS resources and/or AdvCG resources. The AdvSPS/AdvCG scheme may be a semi-static scheduling scheme.

When the video service is provided using AdvSPS/AdvCG resources, the adaptive transmission scheme may be used. In this case, the base station and/or terminal may adaptively change the XRPRB transmission scheme for AdvSPS/AdvCG resources according to a channel quality and/or frame type. The operations according to the SPS/CG scheme may be applied to the AdvSPS/AdvCG scheme. The operations according to the AdvSPS/AdvCG scheme may be applied to the SPS/CG scheme.

AdvSPS/AdvCG may be configure for a QoS flow or DRB classified according to the I-frame/P-frame classification method for the PDU session for video service. In the procedure for configuring QoS flow(s) and/or DRB(s) of the PDU session for video service, the base station may configure RRC parameters and/or MAC parameters for allocation of AdvSPS/AdvCG resources to the terminal using a dedicated control message. The dedicated control message may include AdvSPS/AdvCG configuration information. The AdvSPS/AdvCG configuration information may include the following information element(s).
Scheduling identifier
Allocated frequency information
Physical layer radio resource allocation information
Video service identifier
Validity start time information of allocated radio resources
Valid period information of allocated radio resources
End timer of allocated radio resources
AdvSPS/AdvCG index (e.g., identifier)
Packet set configuration information (e.g., packet set sequence number (SN), packet set start, packet set end, packet SN, packet set type, packet set size, packet set identifier, etc.)
XR HARQ configuration information

The scheduling identifier may refer to an identifier assigned to the terminal for transmission of AdvSPS/AdvCG scheduling information (e.g., PDCCH, DCI). The allocated frequency information may mean information for identifying or indicating a frequency band, transmission carrier, and/or BWP in which radio resources allocated in the AdvSPS/AdvCG scheme exist. The physical layer radio resource allocation information may mean scheduling information (e.g., physical resource element (PRE) index of a PDSCH, PRE index of a PUSCH, XR PRB transmission scheme information) of a physical layer radio resource (e.g., PUSCH or PDSCH) in the time and/or frequency domain.

The video service identifier may mean a QoS flow identifier and/or a radio bearer (e.g., DRB) identifier corresponding to (or mapped to) a video PDU session. Alternatively, the video service identifier may mean an identifier representing a mapping relationship (e.g., correspondence relationship) between AdvSPS/AdvCG resource and DRB (e.g., DRB identifier) or an identifier representing a mapping relationship (e.g., correspondence relationship) between AdvSPS/AdvCG resource and QoS flow identifier. The validity start time information of allocated radio resources may mean information indicating a validity start time at which a physical layer radio resource scheduled in the AdvSPS/AdvCG scheme is valid in the time domain. The validity start time may be an absolute time point or a relative time point. The absolute time point for the validity start time may be indicated by a frame, subframe, slot, subslot, and/or symbol. The relative time point for the validity start time may be indicated as an offset from a specific time point.

The valid period information of allocated radio resources may mean information indicating a period (e.g., time period, time cycle, time duration) in which a radio resource allocated in the AdvSPS/AdvCG scheme is valid in the time domain from the time point indicated by the validity start time information of allocated radio resources. The end timer of allocated radio resources may be a timer (e.g., AdvSPS end timer, AdvCG end timer) indicating an end of validity of the radio resource allocated in the AdvSPS/AdvCG scheme based on the time point indicated by the validity start time information of allocated resources.

The validity of an allocated radio resource (e.g., that the allocated radio resource is valid) may mean that the base station and/or terminal can transmit and receive data (e.g., packet), control information, and/or message using the allocated radio resource. That the allocated radio resource is not valid may mean that the base station and/or terminal cannot transmit and receive data (e.g., packet), control information, and/or message using the allocated radio resource.

The AdvSPS index (e.g., identifier) may indicate one or more AdvSPS resources among a plurality of AdvSPS resources. The AdvCG index (e.g., identifier) may indicate one or more AdvCG resources among a plurality of AdvCG resources.

The packet set configuration information may refer to configuration information of a video packet set (e.g., packet stream) shown in FIG. 12. The XR HARQ configuration information may refer to HARQ retransmission information for transmission of packets belonging to one packet set according to the packet set configuration information. The HARQ retransmission information may include the number of HARQ retransmissions, indication information of enabling each HARQ process, and/or indication information of disabling each HARQ process.

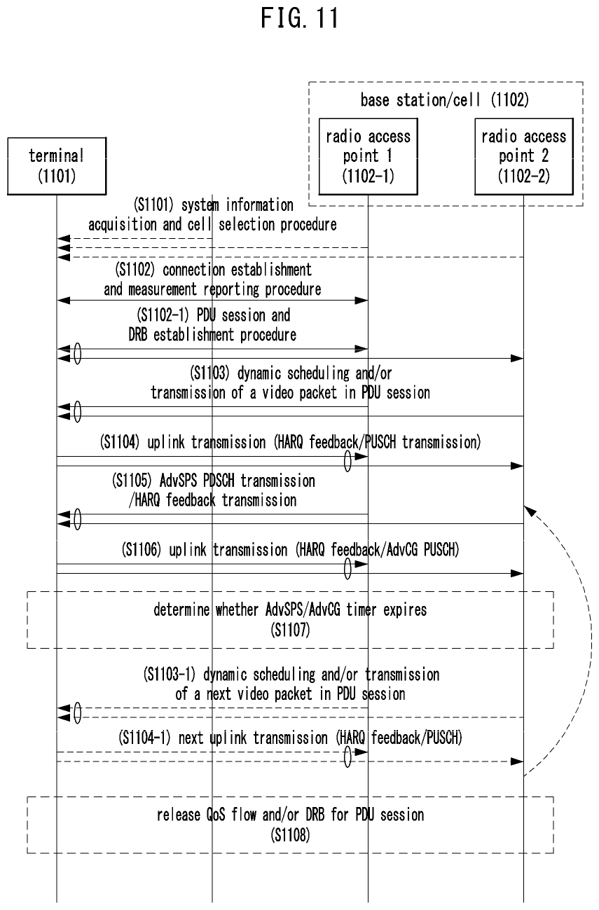

FIG. 11 is a sequence chart illustrating a first exemplary embodiment of a video service radio resource allocation method between a base station and a terminal.

Referring to FIG. 11, a terminal 1101 operating in the RRC inactive state or RRC idle state may perform a cell selection procedure for a base station 1102 (S1101). In the present disclosure, the base station 1102 may mean a cell. The base station 1102 may include a radio access point 1 1102-1 and a radio access point 2 1102-2. When the cell selection procedure is completed, the terminal 1101 may camp on the base station 1102. In the step S1101, the terminal 1101 may acquire system information of the base station 1102 by performing the cell selection procedure. The terminal 1101 may perform a connection establishment procedure with the base station 1102 (S1102). When the connection establishment procedure is completed, the operation state of the terminal 1101 may transition from the RRC inactive state or RRC idle state to the RRC connected state, and the base station 1102 may provide a communication service to the terminal 1101. In the step S1102, a measurement reporting procedure between the terminal 1101 and the base station 1102 may be performed.

After completion of the step S1102 (e.g., connection establishment procedure), PDU session(s) and/or DRB(s) may be established between the terminal 1101 and the base station 1102 (S1102-1). The PDU session established in the step S1102-1 may be the PDU session 804 of FIG. 8 or the PDU session 904 of FIG. 9. The DRB(s) established in the step S1102-1 may be the DRBs 805-1 and 805-2 of FIG. 8 or the DRBs 905-1 and 905-2 of FIG. 9. In the step S1102-1, QoS flow(s) may be configured. The QoS flow(s) configured in the step S1102-1 may be the QoS flows 807-1, 807-2, and 807-3 of FIG. 8 or the QoS flow 907 of FIG. 9. In the step S1102-1, the PDU session(s) for video service may be established through a separate control message, and the DRB(s) may be established according to the above-described QoS flow and radio bearer establishment/management method. The PDU session may mean a video PDU session.

The base station 1102 may transmit dynamic scheduling information and/or video packet (e.g., traffic packet, IP packet) corresponding to a QoS flow identifier and/or DRB identifier of the PDU session to the terminal 1101 (S1103). According to the exemplary embodiment of FIG. 9, the base station 1102 may transmit scheduling information (e.g., dynamic scheduling information) corresponding to the DRB1 905-1 of the QoS flow 907 to the terminal 1101, and transmit first data to the terminal 1101 based on the scheduling information. In addition, the base station 1102 may transmit scheduling information (e.g., dynamic scheduling information) corresponding to the DRB2 905-2 of the QoS flow 907 to the terminal 1101, and transmit second data to the terminal 1101 based on the scheduling information. The DRB1 905-1 of FIG. 9 may be established to transmit the first data, and the DRB2 905-2 of FIG. 9 may be established to transmit the second data.

In the step S1103, the base station 1102 may use a PDCCH (e.g., DCI) masked by a scheduling identifier (e.g., C-RNTI) assigned to the terminal 1101 to transmit the dynamic scheduling information (e.g., physical layer radio resource allocation information) for initial transmission of the packet for the DRB for video service. The initial transmission may refer to transmission of initial data. The base station 1102 may transmit the video packet to the terminal 1101 using a downlink physical layer resource (e.g., PDSCH) addressed by the dynamic scheduling information. In the step S1103, the base station 1102 may use a PDCCH (e.g., DCI) masked by a scheduling identifier (e.g., C-RNTI) assigned to the terminal 1101 to transmit allocation information (e.g., scheduling information) of an uplink physical layer resource (e.g., PUSCH). The uplink physical layer resource may be used to transmit the video packet of the terminal 1101 to the base station 1102.

In the step S1103, the PDCCH (e.g., DCI) transmission and/or PDSCH (e.g., video packet) transmission may be performed at a time when the radio resource allocated in the AdvSPS/AdvCG scheme is valid. In other words, a start time of the PDCCH (e.g., DCI) transmission and/or PDSCH (e.g., video packet) transmission may be interpreted as a validity start time of the allocated radio resource. In the step S1103, the PDCCH (e.g., DCI) or PDSCH may include an indicator notifying that the radio resource allocated in the AdvSPS/AdvCG scheme can be used. The indicator may indicate validity of the allocated radio resource.

The AdvSPS/AdvCG resources may be preconfigured by the base station 1102. For example, before the step S1103, the base station 1102 may transmit AdvSPS/AdvCG configuration information to the terminal 1101. The terminal 1101 may receive the AdvSPS/AdvCG configuration information from the base station 1102. The AdvSPS/AdvCG configuration information may indicate AdvSPS/AdvCG resources. The AdvSPS/AdvCG configuration information may refer to AdvSPS/AdvCG configuration parameters. Based on an AdvSPS/AdvCG resource validity check method (e.g., validity indication method), the base station and/or terminal may retransmit the video packet by using the preconfigured (e.g., pre-allocated) AdvSPS/AdvCG resources. The AdvSPS/AdvCG resources may be configured (e.g., allocated) by RRC parameter(s) and/or MAC parameter(s). The video packet retransmission procedure using AdvSPS/AdvCG resources may be performed when the initial video packet transmission procedure based on dynamic scheduling fails.

Since the validity start time information of allocated radio resources can be estimated by the PDCCH (e.g., DCI) transmission and/or PDSCH (e.g., video packet) transmission in the step S1103, it may be replaced with information estimated by the PDCCH (e.g., DCI) transmission and/or PDSCH (e.g., video packet) transmission. The AdvSPS/AdvCG configuration parameters may not include the validity start time information of allocated radio resources.

In the step S1103, when the PDCCH (e.g., DCI) transmission and/or PDSCH (e.g., video packet) transmission indicate a time point at which the radio resource allocated in the AdvSPS/AdvCG scheme is valid, the AdvSPS end timer and/or AdvCG end timer may be (re)started at the execution time of the step S1103 (e.g., PDCCH transmission time point, PDSCH transmission time point).

In the step S1103, the terminal 1101 may receive the PDSCH (e.g., video packet) from the base station 1102. The terminal 1101 may transmit HARQ feedback information (e.g., ACK/NACK information) for the PDSCH to the base station 1102 (S1104). When the scheduling information of the PUSCH (e.g., video packet) is received in the step S1103, the terminal 1101 may transmit the video packet to the base station 1102 using the PUSCH resource indicated by the scheduling information (S1104). In the step S1104, when the transmission time point of the PUSCH indicates a time point at which the AdvCG resource for retransmission of the uplink video packet can be used, the AdvCG end timer may be (re)started at the time at which the AdvCG resource can be used.

In the step S1104, the base station 1102 may receive the HARQ feedback information and/or PUSCH (e.g., video packet) from the terminal 1101. The base station 1102 may retransmit the video packet to the terminal 1101 using the AdvSPS resource based on the HARQ feedback information and/or a preconfigured HARQ retransmission scheme (S1105). In other words, if the initial transmission of the video packet fails, the base station 1102 may retransmit the video packet to the terminal 1101 using the AdvSPS resource. In the step S1105, the base station 1102 may transmit HARQ feedback information (e.g., ACK/NACK information) for the PUSCH (e.g., video packet) of the terminal 1101 to the terminal 1101.

When the validity of AdvCG resource is confirmed in the step S1103 and/or S1104 (e.g., when the AdvCG resource is confirmed to be usable in the step S1103 and/or S1104), the terminal 1101 may retransmit the video packet according to the HARQ feedback information for the downlink transmission of the base station and/or the HARQ retransmission scheme (S1106). If the initial transmission of the video packet fails, the terminal 1101 may retransmit the video packet to the base station 1102 using the AdvCG resource.

While the video packet retransmission operation using AdvSPS/AdvCG resource is performed, the terminal 1101 and/or base station 1102 may determine (e.g., monitor) whether the AdvSPS end timer and/or AdvCG end timer expires. In other words, while retransmission of the video packet using AdvSPS/AdvCG resource is performed and the AdvSPS end timer and/or AdvCG end timer is running, the terminal 1101 and/or base station 1102 may determine (e.g., monitor) whether the AdvSPS timer and/or AdvCG end timer expires (S1107).

When it is identified in the step S1107 that the AdvSPS timer (e.g., AdvSPS end timer) expires, the base station 1102 cannot perform the retransmission operation using the AdvSPS resource, and the terminal 1101 may not perform a monitoring operation and/or reception operation on the AdvSPS resource for reception of the retransmitted video packet. When it is identified in the step S1107 that the AdvCG timer (e.g., AdvCG end timer) expires, the terminal 1101 cannot perform the retransmission operation using the AdvCG resource, and the base station 1102 may not perform a monitoring operation and/or reception operation on the AdvCG resources for reception of the retransmitted video packet. When the AdvSPS/AdvCG timer expires, the AdvSPS/AdvCG resource may not be valid in the terminal 1101 and/or base station 1102. That the AdvSPS/AdvCG resource is not valid may mean that although configuration of RRC parameter(s) and/or MAC parameter(s) for AdvSPS/AdvCG is not released while the QoS flow(s) and/or DRB(s) corresponding to the PDU session of video service are not released, the base station 1102 and/or terminal 1101 cannot use the AdvSPS/AdvCG resource for the purpose of transmission and reception operations.

When the initial transmission operation of the video packet is successfully completed on the PDSCH in the step S1103 and/or S1105 or when the retransmission operation of the video packet is successfully completed in the AdvSPS resource, the base station 1102 may perform a transmission operation of dynamic scheduling information for transmission of the next video packet and/or an initial transmission operation for the next video packet (S1103-1).

When the initial transmission operation of the video packet is successfully completed on the PUSCH in the step S1104 and/or S1106 or when the retransmission operation of the video packet is successfully completed in the AdvCG resource, the terminal 1101 may perform an initial transmission operation for the next video packet based on dynamic scheduling information for transmission of the next video packet (S1104-1). The dynamic scheduling information may be received by the base station 1102.

When the AdvSPS/AdvCG timer expires in the step S1107, the AdvSPS/AdvCG resource may not be valid in the terminal 1101 and/or base station 1102. In this case, the validity of AdvSPS/AdvCG resource may be restored in the steps S1103-1 and/or S1104-1. The base station 1102 may perform a retransmission operation for the initial transmission using the AdvSPS resource allocated according to the preconfigured values of RRC parameter(s) and/or MAC parameter(s) in the step S1103-1. Accordingly, the AdvSPS timer (e.g., AdvSPS end timer) may be (re)started. The terminal 1101 may perform a retransmission operation for the initial transmission using the AdvCG resource allocated according to the preconfigured values of RRC parameter(s) and/or MAC parameter(s) in the step S1104-1. Accordingly, the AdvCG timer (e.g., AdvCG end timer) may be (re)started.

When the initial transmission operation and/or the retransmission operation for the video packet is successfully completed before the AdvSPS end timer expires, the base station 1102 may perform the step S1103-1. When the initial transmission operation and/or the retransmission operation for the video packet is successfully completed before the AdvCG end timer expires, the terminal 1101 may perform the step S1104-1.

When the steps S1103-1 and/or S1104-1 are completed, the terminal 1101 and/or base station 1102 may perform the steps S1105 to S1107 according to HARQ feedback information. Until the video service ends, the terminal 1101 and/or the base station 1102 may selectively and repeatedly perform the steps S1103 to S1107.

When the video service ends, the base station 1102 and/or the terminal 1101 may release the QoS flow(s) and/or DRB(s) for the PDU session (e.g., video PDU session) (S1108). In other words, the PDU session may be released in the step S1108. In the step S1108, AdvSPS/AdvCG resources may be released. Release of the AdvSPS/AdvCG resources in the step S1108 may mean complete release of the RRC parameter(s) and/or MAC parameter(s) for AdvSPS/AdvCG configuration, not loss of validity of the AdvSPS/AdvCG resources. The step S1108 may be performed when the communication service (e.g., video service) provided by the base station 1102 ends or when the transmission/reception operation of video packets (e.g., data) is completed.

Indication information indicating that the AdvSPS/AdvCG resource preconfigured in the above-described procedure of FIG. 11 can be used for packet (e.g., video packet) retransmission may be transmitted and received in a procedure for transmitting and receiving HARQ feedback information indicating NACK. The indication information may be validity information of the AdvSPS/AdvCG resource. The preconfigured AdvSPS/AdvCG resource may be available from a time point of transmitting and receiving of the HARQ feedback information indicating NACK.

Scheduling information for a physical layer radio resource for the adaptive retransmission scheme according to the SPS/CG scheme and/or retransmission according to the AdvSPS/AdvCG scheme may be allocated based on RRC parameter(s) and/or MAC parameter(s) preconfigured in compliance with the existing SPS/CG scheme.

When transmission for DRBi/DRBp (e.g., video packet transmission) is performed using the SPS/CG resource and/or AdvSPS/AdvCG resource, the base station may transmit scheduling information (e.g., PDSCH allocation information, PUSCH allocation information, XR PRB transmission scheme information) masked by a scheduling identifier (e.g., C-RNTI, cs-RNTI, xr-RNTI) assigned to the terminal in the SPS/CG resource and/or AdvSPS/AdvCG resource. The scheduling information within a PDCCH (e.g., DCI) applied to initial transmission using the SPS/CG resource and/or AdvSPS/AdvCG resource may be applied to a retransmission operation of PRBs (e.g., transport block) using the SPS/CG resource and/or AdvSPS/AdvCG resource. The terminal may receive the PDCCH (e.g., DCI) for the SPS/CG resource and/or AdvSPS/AdvCG resource according to configuration parameters of the SPS/CG resource and/or AdvSPS/AdvCG resource, and may obtain the XR PRB transmission scheme information (e.g., scheduling information) included in the PDCCH. The terminal may perform a PRB reception operation on the PDSCH according to the SPS scheme or the AdvSPS scheme using the XR PRB transmission scheme information (e.g., scheduling information). The terminal may perform a PRB transmission operation on the PUSCH according to the CG scheme or the AdvCG scheme using the XR PRB transmission scheme information (e.g., scheduling information).

FIG. 12 is a conceptual diagram illustrating a first exemplary embodiment of a GOP for video service.

Referring to FIG. 12, a GOP may include one or more packet sets, and each packet set 1201 may include one or more packets. In other words, a GOP may include packets. The packet may mean a video packet, a traffic packet, and/or an IP packet. The packet set may mean a packet stream. A first packet set 1201-1 may correspond to an I-frame, a second packet set 1201-2 and a third packet set 1201-3 may correspond to a B-frame, and a fourth packet set 1201-4 may correspond to a P-frame. Each packet set 1201 may include a plurality of packets. Each packet 1205 may be represented by a packet sequence number (SN) 1204.

Configuration information of the packet set 1201 may include information indicating a start 1202 and/or end 1203 of the packet set. The packet SN 1204 may indicate an order of a packet within one packet set. The packet SN 1204 may start again from the beginning within each packet set 1201. The packet SN 1204 may start from 0 or 1. Alternatively, the packet SN 1204 may be assigned within all packet sets included in the GOP. In other words, the packet SN 1204 may start again from the beginning within each GOP. In this case, when a packet SN 1204-1 is 8 at an end 1203-1 of the first packet set 1201-1, a packet SN 1204-2 at a start 1202-2 of the second packet set 1201-2 may be 9.

1201 may collectively denote 1201-1, 1201-2, 1201-3, and/or 1201-4. 1202 may collectively denote 1202-1, 1202-2, 1202-3, and/or 1202-4. 1203 may collectively denote 1203-1, 1203-2, 1203-3, and/or 1203-4. 1204 may collectively denote 1204-1, 1204-2, 1204-3, and/or 1204-4.

The core network (e.g., UPF, SMF, AMF) may generate packet set configuration information on a packet set basis, and transmit the packet set configuration information to the RAN. The packet set configuration information may include at least one of an SN of the packet set, start of the packet set, end of the packet set, SN(s) of packet(s), size of the packet set, and type of the packet set. The packet set SN may be the SN of the packet set 1201. The size of the packet set may be expressed in bytes. Alternatively, the size of the packet set may be derived based on the size of each packet, the start of the packet set, the end of the packet set, and/or the SN(s) of the packet(s). The packet set type may indicate importance of the packet set or the frame attribute (e.g., I-frame, B-frame, or P-frame) of the packet set. The frame attribute may indicate the frame type.

The RAN (e.g., base station, terminal) may receive the packet set configuration information from the core network. The packet set configuration information may be configured on a packet set basis. The packet set configuration information may be used for transmission and reception of packets for video service. The RAN may establish DRB(s) for video service based on the packet set configuration information. The base station may change a scheduling function including a transmission scheme for DRB on a packet set basis. In other words, the base station may perform the scheduling function including the transmission scheme for DRB on a packet set basis.

When the video service is provided based on dynamic scheduling, the size, MCS level, and/or HARQ retransmission scheme (e.g., number of HARQ retransmissions, enabling/disabling of an HARQ process) of the allocated radio resource may be changed on a packet set basis in consideration the type of packet set (e.g., QoS attribute). When XR packets are transmitted in the SPS/CG scheme or the AdvSPS/AdvCG scheme in consideration of a periodicity of the XR packets, the packet set configuration information may be included in SPS/CG or AdvSPS/AdvCG configuration parameters. The XR packets may be traffic packets for video service.

An identifier of the packet set or an AdvSPS/AdvCG index (e/g/, identifier) may be used to select an SPS/CG resource or an AdvSPS/AdvCG resource in consideration of the frame type of the packet set. The identifier of the packet set may be used to represent a correspondence relationship (e.g., association relationship) for the SPS/CG resource or AdvSPS/AdvCG resource configured using the packet set configuration information (i.e., according to the size of the packet set, delay budget of the packet set, importance of the packet set, and/or the type of the packet set (e.g., importance of the packet set, frame attribute (e.g., I-frame, P-frame, or the like))). Alternatively, the identifier of the packet set may be used for identification of the SPS/CG resource or the AdvSPS/AdvCG resource.

When the identifier of the packet set is not configured, the corresponding relationship (e.g., association relationship) for the SPS/CG resource or the AdvSPS/AdvCG resource may be represented using the AdvSPS/AdvCG index (e.g., identifier) according to the packet set configuration information (e.g., packet set size, packet set delay budget, packet set importance, and/or packet set type (e.g., packet set importance and/or frame attribute (e.g., I-frame, P-frame)).

Based on the periodicity of traffic packets (e.g., video packets) for video service and the exemplary embodiment of FIG. 11, another exemplary embodiment of the resource allocation method for video packet transmission between the base station and the terminal may be considered.

Referring to FIG. 12, video packets may constitute one packet set (e.g., packet stream), and configuration information of the packet set may be configured. The packet set configuration information may include at least one of a start of the packet set, end of the packet set, SN(s) of the packet(s), or SN of the packet set. The packet set configuration information may be included in DRB configuration parameters for video service. The packet set configuration information may be included in SPS/CG or AdvSPS/AdvCG configuration information (e.g., parameters).

Referring to FIG. 11, the base station 1102 may transmit dynamic scheduling information and/or traffic packets corresponding to a QoS flow identifier and/or a DRB identifier of a PDU session (e.g., video PDU session) to the terminal 1101 (S1103). In the step S1103, the base station 1102 may transmit dynamic scheduling information (e.g., physical layer resource allocation information) for initial transmission a DRB packet for video service through a physical layer control channel (e.g., PDCCH or DCI) masked by a scheduling identifier (e.g., C-RNTI) assigned to the terminal 1101. In the step S1103, the base station 1102 may transmit the video packet to the terminal 1101 using a downlink physical layer radio resource (e.g., PDSCH) addressed by the scheduling information. In the step S1103, the base station 1102 may transmit allocation information (e.g., scheduling information) for an uplink physical layer resource (e.g., PDSCH) to the terminal 1101 by using a PDCCH (e.g., DCI) masked by the scheduling identifier (e.g., C-RNTI) assigned to the terminal 1101. The uplink physical layer resource may be used to transmit the video packet of the terminal 1101 to the base station 1102.

In the step S1103, PDCCH (e.g., DCI) transmission and/or PDSCH (e.g., video packet) transmission may be performed at a time when the radio resource allocated in the AdvSPS/AdvCG scheme is valid. In other words, a start time of the PDCCH (e.g., DCI) transmission and/or PDSCH (e.g., video packet) transmission may be interpreted as a validity start time of the allocated radio resource. In the step S1103, the PDCCH (e.g., DCI) or PDSCH may include an indicator indicating that the radio resource allocated in the AdvSPS/AdvCG scheme can be used, information indicating a validity time when the radio resource allocated in the AdvSPS/AdvCG scheme can be used, information indicating a specific SPS/CG resource among configured SPS/CG resources, and/or information indicating a specific AdvSPS/AdvCG resource among configured AdvSPS/AdvCG resources. The indicator may indicate validity of the allocated radio resource. The information indicating a specific SPS/CG resource or a specific AdvSPS/AdvCG resource may be an identifier of a packet set and/or an AdvSPS/AdvCG index (e.g., identifier). In other words, the base station 1102 and/or terminal 1101 may confirm (e.g., identify) a SPS/CG resource or AdvSPS/AdvCG resource having a correspondence relationship (e.g., association relationship) with the packet set by using the packet set identifier and/or AdvSPS/AdvCG index (e.g., identifier).

The indicator (e.g., information) indicating the validity start time and/or validity of the AdvSPS/AdvCG resource in the step S1103 may be transmitted at the start 1202 of the packet set or a transmission time of a first packet 1205 of the packet set. In other words, transmission of the indicator indicating the validity start time and/or the validity of AdvSPS/AdvCG resource in the step S1103 may be started at a start time point of transmission of one packet set. The radio resource for transmission of the packet set whose validity is indicated in the step S1103 may be valid until the end 1203 of the packet set, separately defined valid period, or expiration time point of an end timer (e.g., packet set timer).

The base station 1102 or the terminal 1101 may use the AdvSPS/AdvCG resource preconfigured for video packet transmission based on RRC parameter(s) and/or MAC parameter(s) according to the method for identifying (e.g., indicating) validity of the AdvSPS/AdvCG resource. The video packet transmission of the base station 1102 or terminal 1101 may be an initial transmission or retransmission of another packet.

Since validity start time information of the allocated radio resource may be estimated by the PDCCH (e.g., DCI) transmission and/or PDSCH (e.g., video packet) transmission in the step S1103, the validity start time information of the allocated radio resource may be replaced with information estimated by the PDCCH (e.g., DCI) transmission and/or PDSCH (e.g., video packet) transmission. The AdvSPS/AdvCG configuration parameters may not include the validity start time information of the allocated radio resource.

When the PDCCH (e.g., DCI) transmission and/or PDSCH (e.g., video packet) transmission of the step S1103 indicates a time at which the radio resource allocated in the AdvSPS/AdvCG scheme is valid or a start of a new packet set, the AdvSPS packet set timer and/or the AdvCG packet set timer may be (re)started at the start 1202 of the packet set or a transmission time point of the first packet 1205 of the packet set in the step S1103.

In the step S1103, the terminal 1101 may receive a PDSCH (e.g., video packet) from the base station 1102. The terminal 1101 may transmit HARQ feedback information (e.g., ACK/NACK information) for the PDSCH to the base station 1102 (S1104). When scheduling information for a PUSCH (e.g., video packet) is received in the step S1103, the terminal 1101 may transmit a video packet to the base station 1102 using a PUSCH resource indicated by the scheduling information (S1104). When a PUSCH transmission time indicates a start of a packet set (e.g., a transmission time of the first packet of the packet set) or a time point at which the AdvCG resource for transmission of the new packet set is available in the step S1104, the AdvCG packet set timer set may be (re)started.

In the step S1104, the base station 1102 may receive HARQ feedback information and/or PUSCH (e.g., video packet) from the terminal 1101. The base station 1102 may (re)transmit the video packet to the terminal 1101 using an AdvSPS resource based on the HARQ feedback information and/or preconfigured HARQ retransmission scheme (S1105). In the step S1105, the base station 1102 may perform an initial transmission operation of another packet in the packet set (e.g., a new packet in an un-transmitted packet set). In the step S1105, the base station 1102 may transmit HARQ feedback information (e.g., ACK/NACK information) for the PUSCH (e.g., video packet) of the terminal 1101 to the terminal 1101.

When the validity of AdvCG resource is identified in the step S1103 and/or S1104 (e.g., when the AdvCG resource is confirmed to be usable in the step S1103 and/or S1104), the terminal 1101 may retransmit HARQ feedback information for the downlink transmission of the base station 1102 and/or the video packet according to the HARQ retransmission scheme (S1106). In the step S1106, the terminal 1101 may perform an initial transmission operation of another packet in the packet set (e.g., a new packet in an un-transmitted packet set).

While the video packet retransmission operation using the AdvSPS/AdvCG resource is performed, the terminal 1101 and/or the base station 1102 may determine (e.g., monitor) whether the AdvSPS packet set timer and/or the AdvCG packet set timer expires. In other words, while the video packet (re)transmission operation using the AdvSPS/AdvCG resource is performed and the AdvSPS packet set timer and/or AdvCG packet set timer is running, the terminal 1101 and/or base station 1102 may determine (e.g., monitor) whether the AdvSPS packet set timer and/or the AdvCG packet set timer expires (S1107). Alternatively, while the video packet transmission is performed in the step S1107, the terminal 1101 and/or base station 1102 may determine (e.g., monitor) whether the packet set ends.

When it is identified in the step S1107 that the AdvSPS packet set timer expires or that the packet set ends, the base station 1102 cannot perform a retransmission operation using the AdvSPS resource, and the terminal 1101 may not perform a monitoring operation and/or reception operation on the AdvSPS resource for video packet reception. When it is identified in the step S1107 that the AdvSPS packet set timer expires or that the packet set ends, the terminal 1101 cannot perform a retransmission operation using the AdvCG resource, and the base station 1101 may not perform a monitoring operation and/or reception operation on the AdvCG resource for video packet reception. When it is identified that the AdvSPS/AdvCG packet set timer expires or that the packet set ends, the AdvSPS/AdvCG resource may be invalid in the terminal 1101 and/or base station 1102. That the AdvSPS/AdvCG resource is not valid may mean that although RRC parameter(s) and/or MAC parameter(s) for AdvSPS/AdvCG are not released while the QoS flow and/or DRB corresponding to the PDU session of the video service are not released, the base station 1102 and/or terminal 1101 cannot use the AdvSPS/AdvCG resource for the purpose of transmission and reception operations.

When the initial transmission operation of the video packet is successfully completed in the PDSCH in the step S1103 and/or S1105 or when the retransmission operation of the video packet is successfully completed in the AdvSPS resource, the base station 1102 may perform a transmission operation of dynamic scheduling information for transmission of a next video packet (e.g., un-transmitted packet within the packet set) and/or an initial transmission operation for the next video packet (S1103-1).

When the initial transmission operation of the video packet is successfully completed in the PUSCH in the step S1104 and/or S1106 or when the retransmission operation of the video packet is successfully completed in the AdvCG resource, the terminal 1101 may perform an initial transmission operation for the next video packet (e.g., un-transmitted packet within the packet set) based on the dynamic scheduling information for transmission of the next video packet (S1104-1). The dynamic scheduling information may be received from the base station 1102.

A hybrid scheduling scheme including features of dynamic scheduling and SPS/CG scheduling or features of dynamic scheduling and AdvSPS/AdvCG scheduling may be used for video packet transmission. In a connection establishment procedure for video service, one or more parameters below may be configured for the SPS/CG scheme or the AdvSPS/AdvCG scheme for video packet transmission.
Radio resource allocation information
Information on the number of antenna ports
MCS information
HARQ information

The radio resource allocation information may include time domain allocation information, frequency domain allocation information, information on a period in which radio resource allocation is valid, and/or transport block size (TBS) information. The TBS information may mean TBS parameter(s). The time domain allocation information may refer to configuration information (e.g., information indicating position(s) of slots and/or symbols) for a PDSCH resource or PUSCH resource. The frequency domain allocation information may mean configuration information (e.g., information indicating a carrier, BWP, and/or subcarrier(s)) for the PDSCH resource or PUSCH resource. The information on the period in which radio resource allocation is valid may include at least one of a start time of a valid period, offset indicating the start time of the valid period, length of the valid period, or end time of the valid period.

The time domain allocation information, frequency domain allocation information, information on the period in which radio resource allocation is valid, and/or TBS information may be configured in a table form (or list form). The MCS information may represent a modulation and coding level applied to video packet transmission. The MCS information may be configured in a table form (or list form). The HARQ information (e.g., HARQ feedback information) may include a configuration parameter of an HARQ process ID, number of HARQ retransmissions, and/or information indicating whether HARQ feedback is performed (e.g., enable indicator or disable indicator).

One or more parameters below may be transmitted by dynamic scheduling.
SPS/CG resource identifier information (e.g., packet set identifier information)
Information on a valid period in which SPS/CG resources are valid (e.g., start, offset, length, and/or end of the valid period)
AdvSPS/AdvCG resource identifier information (e.g., packet set identifier information)
Information on a valid period in which AdvSPS/AdvCG resources are valid (e.g., start, offset, length, and/or end of the valid period)
Radio resource location information
TBS index
Antenna port index
MCS index
HARQ process ID
HARQ enable indicator or HARQ disable indicator

The SPS/CG resource identifier information (e.g., packet set identifier information) may indicate a specific SPS/CG resource according to a correspondence relationship (e.g., association relationship) based on configuration information of the packet set (e.g., size of the packet set, delay budget of the packet set, importance of the packet set, and/or type of the packet set (e.g., importance of the packet set and/or frame attribute (e.g., I-frame or P-frame) of the packet set). The SPS/CG resource identifier information may indicate activation of the specific SPS/CG resource.

The AdvSPS/AdvCG resource identifier information (e.g., packet set identifier information) may indicate a specific AdvSPS/AdvCG resource according to a correspondence relationship (e.g., association relationship) for an AdvSPS/AdvCG resource based on configuration information of the packet set (e.g., size of the packet set, delay budget of the packet set, importance of the packet set, and/or type of the packet set (e.g., importance of the packet set and/or frame attribute (e.g., I-frame or P-frame) of the packet set). The AdvSPS/AdvCG resource identifier information may indicate activation of the specific AdvSPS/AdvCG resource.

The radio resource location information may indicate the location of the radio resource. The location information of radio resource may indicate a radio resources (e.g., slot index, symbol index, subcarrier index) in SPS/CG or AdvSPS/AdvCG configuration information (e.g., configuration parameters). An index may mean an indicator.

The TBS index may indicate one TBS index within a TBS table (e.g., TBS list) configured by the SPS/CG or AdvSPS/AdvCG configuration information. Alternatively, when the SPS/CG or AdvSPS/AdvCG configuration information does not include a TBS table (e.g., TBS list), the TBS index means a TBS applied to transmission using the SPS/CG resource or AdvSPS/AdvCG resource. The antenna port index may indicate one antenna port among antenna ports configured by the SPS/CG or AdvSPS/AdvCG configuration information. The MCS index may indicate one MCS index within an MCS table (e.g., MCS list) configured by the SPS/CG or AdvSPS/AdvCG configuration information. Alternatively, if the SPS/CG or AdvSPS/AdvCG configuration information does not include an MCS table (e.g., MCS list), the MCS index may mean an MCS applied to transmission using the SPS/CG resource or AdvSPS/AdvCG resource.

The dynamic scheduling information may be transmitted to the terminal using a PDDCH (e.g., DCI) or MAC CE. When the dynamic scheduling information is transmitted using a PDCCH (e.g., DCI), the PDCCH (e.g., DCI) may be masked by C-RNTI, cs-RNTI, or xr-RNTI.

The base station may transmit dynamic scheduling information for video packet transmission in at least one of the following situations.
A situation in which the base station or terminal transmits the first packet within the packet set 1201
A situation in which at least one of a carrier, BWP, antenna port, MCS level, or TCI state (e.g., beam) for packet transmission and reception between the base station and the terminal needs to be changed
A situation where the terminal requested dynamic scheduling

The terminal may receive the dynamic scheduling information for video packet transmission from the base station. The terminal may receive a video packet by performing a monitoring operation for the SPS resource or AdvSPS resource based on the dynamic scheduling information. The terminal may transmit a video packet using the CG resource or

AdvCG resource based on the dynamic scheduling information. Alternatively, the base station may transmit dynamic scheduling information to the terminal for each packet transmission procedure using the SPS/CG resource or the AdvSPS/AdvCG resource. In other words, the dynamic scheduling information may be transmitted in each packet transmission procedure.

The terminal may apply a hybrid scheduling scheme using both SPS/CG and/or AdvSPS/AdvCG configuration information and dynamic scheduling information. In this case, video packets can be efficiently transmitted and received according to the attribute of the packet set.

The hybrid scheduling scheme may be a dynamic scheduling scheme0 to which a scheduling periodicity (e.g., scheduling cycle) is applied. The base station (e.g., scheduler of the base station) may determine a hybrid scheduling periodicity (e.g., cycle) according to a packet attribute and may transmit dynamic scheduling information according to the hybrid scheduling periodicity. The terminal may obtain the dynamic scheduling information (e.g., hybrid scheduling information) by performing a monitoring operation for a physical layer control channel (e.g., PDCCH, DCI) according to the hybrid scheduling periodicity (e.g., cycle). The terminal may receive a video packet (e.g., traffic packet) on a downlink channel using the dynamic scheduling information. The terminal may transmit a video packet (e.g., traffic packet) on an uplink channel using the dynamic scheduling information.

When the hybrid scheduling scheme is applied for service provision, the base station may transmit hybrid scheduling configuration information to the terminal using a control message (e.g., RRC message) in a connection establishment procedure between the base station and the terminal. The hybrid scheduling configuration information includes at least one of a hybrid scheduling configuration indicator, hybrid scheduling cycle (e.g., periodicity), information indicating a start time of hybrid scheduling, hybrid scheduling offset information, an identifier of a DRB to which hybrid scheduling is applied, or an identifier of a logical channel to which hybrid scheduling is applied.

In the hybrid scheduling configuration information, time domain configuration information (e.g., hybrid scheduling cycle (e.g., periodicity), information indicating a start time of hybrid scheduling, information of an offset of hybrid scheduling) may be configured in units of subframe(s), slot(s), and subslot(s), symbol(s), and/or PDCCH (e.g., CORESET). The hybrid scheduling configuration information may include information on one or more hybrid scheduling cycles (e.g., periodicities) such that each cycle (periodicity) is mapped to each packet set for XR service. The hybrid scheduling configuration information may include information indicating a start time of hybrid scheduling, information indicating an offset of hybrid scheduling, an identifier of a DRB to which hybrid scheduling is applied, and/or an identifier of a logical channel to which hybrid scheduling is applied, which corresponds to each of a plurality of packet sets or a plurality of hybrid scheduling cycles (e.g., periodicities).

The base station and the terminal may transmit and receive information indicating whether hybrid scheduling is applied using a MAC CE or a physical layer control channel. The information indicating whether hybrid scheduling is applied may be an activation indicator or a deactivation indicator of hybrid scheduling.

With respect to the operation of the timer defined or described in the present disclosure, although operations such as start, stop, reset, restart, or expire of the defined timer are not separately described, they mean or include the operations of the corresponding timer or a counter for the corresponding timer. The terminal may refer to a UE, a terminal, an access terminal, a mobile terminal, a station, a subscriber station, a mobile station, a portable subscriber station, a node, a device), an Internet of Thing (IoT) device, or a mounted apparatus (e.g., a mounted module/device/terminal or an on-board device/terminal).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
establishing a packet data unit (PDU) session and one or more data radio bearers (DRBs) with a base station;
receiving, from the base station, first downlink control information (DCI) including first dynamic scheduling information corresponding to a first DRB among the one or more DRB s;
performing an initial transmission/reception operation for first data with the base station based on the first dynamic scheduling information; and
performing a re-transmission/reception operation for the first data with the base station based on first semi-static scheduling information configured by the base station.

2. The method according to claim 1, wherein the one or more DRBs include the first DRB and a second DRB, the first DRB and the second DRB are mapped to one quality of service (QoS) flow, the first DRB is used for transmission and reception of the first data, the second DRB is used for transmission and reception of second data, and the first data and the second data have different importance.

3. The method according to claim 2, wherein the first semi-static scheduling information is configured for the first DRB, and second semi-static scheduling information configured for the second DRB is distinguished from the first semi-static scheduling information.

4. The method according to claim 1, wherein when downlink communication is performed between the terminal and the base station, the first semi-static scheduling information indicates semi-persistent (SPS) resources, and when uplink communication is performed between the terminal and the base station, the first semi-static scheduling information indicates configured grant (CG) resources.

5. The method according to claim 1, wherein the first DCI further includes validity time information of the first semi-static scheduling information, and the re-transmission/reception operation for the first data is performed within a valid time indicated by the validity time information.

6. The method according to claim 5, further comprising: when the valid time expires, receiving, from the base station, second DCI including second dynamic scheduling information for new data.

7. The method according to claim 1, further comprising: when a communication service provided by the base station is terminated, performing, with the base station, a release procedure of the PDU session and the one or more DRBs, wherein in the release procedure, resources indicated by the first-semi-static scheduling information are released.

8. The method according to claim 1, further comprising: when a video packet is generated, classifying the video packet into the first data and second data based on a classification condition, wherein the first data is mapped to the first DRB, the second data is mapped to a second DRB among the one or more DRBs, the first data is an I-frame, and the second data is a P-frame.

9. A method of a base station, comprising:
establishing a packet data unit (PDU) session and one or more data radio bearers (DRBs) with a terminal;
transmitting, to the terminal, first semi-static scheduling information corresponding to a first DRB among the one or more DRBs;
transmitting, to the terminal, first downlink control information (DCI) including first dynamic scheduling information corresponding to the first DRB;
performing an initial transmission/reception operation for first data with the terminal based on the first dynamic scheduling information; and
performing a re-transmission/reception operation for the first data with the terminal based on the first semi-static scheduling information.

10. The method according to claim 9, wherein the one or more DRBs include the first DRB and a second DRB, the first DRB and the second DRB are mapped to one quality of service (QoS) flow, the first DRB is used for transmission and reception of the first data, the second DRB is used for transmission and reception of second data, and the first data and the second data have different importance.

11. The method according to claim 10, further comprising: transmitting, to the terminal, second semi-static scheduling information corresponding to the second DRB, wherein the second semi-static scheduling information configured for the second DRB is distinguished from the first semi-static scheduling information configured for the first DRB.

12. The method according to claim 9, wherein when downlink communication is performed between the terminal and the base station, the first semi-static scheduling information indicates semi-persistent (SPS) resources, and when uplink communication is performed between the terminal and the base station, the first semi-static scheduling information indicates configured grant (CG) resources.

13. The method according to claim 9, wherein the first DCI further includes validity time information of the first semi-static scheduling information, and the re-transmission/reception operation for the first data is performed within a valid time indicated by the validity time information.

14. The method according to claim 13, further comprising: when the valid time expires, transmitting, to the terminal, second DCI including second dynamic scheduling information for new data.

15. The method according to claim 9, further comprising: when a communication service provided by the base station is terminated, performing, with the terminal, a release procedure of the PDU session and the one or more DRBs, wherein in the release procedure, resources indicated by the first-semi-static scheduling information are released.

16. A terminal comprising a processor, wherein the processor causes the terminal to perform:
establishing a packet data unit (PDU) session and one or more data radio bearers (DRBs) with a base station;
receiving, from the base station, first downlink control information (DCI) including first dynamic scheduling information corresponding to a first DRB among the one or more DRBs;
performing an initial transmission/reception operation for first data with the base station based on the first dynamic scheduling information; and
performing a re-transmission/reception operation for the first data with the base station based on first semi-static scheduling information configured by the base station.

17. The terminal according to claim 16, wherein the one or more DRBs include the first DRB and a second DRB, the first DRB and the second DRB are mapped to one quality of service (QoS) flow, the first DRB is used for transmission and reception of the first data, the second DRB is used for transmission and reception of second data, and the first data and the second data have different importance.

18. The terminal according to claim 16, wherein when downlink communication is performed between the terminal and the base station, the first semi-static scheduling information indicates semi-persistent (SPS) resources, and when uplink communication is performed between the terminal and the base station, the first semi-static scheduling information indicates configured grant (CG) resources.

19. The terminal according to claim 16, wherein the first DCI further includes validity time information of the first semi-static scheduling information, and the re-transmission/reception operation for the first data is performed within a valid time indicated by the validity time information.

20. The terminal according to claim 16, wherein the processor further causes the terminal to perform: when a communication service provided by the base station is terminated, performing, with the base station, a release procedure of the PDU session and the one or more DRBs, wherein in the release procedure, resources indicated by the first-semi-static scheduling information are released.
